(19) United States
(12) Patent Application Publication
(10) Pub. No.: US 2026/0227284 A1
(43) Pub. Date: Aug. 6, 2026

(54) ELEVATOR TRACTION MACHINE, ROLLING BEARING, AND ROLLING BEARING DIAGNOSTIC DEVICE

(71) Applicants: Mitsubishi Electric Corporation, Tokyo (JP); Mitsubishi Electric Building Solutions Corporation, Tokyo (JP)

(72) Inventors: Naokatsu TAKARA, Tokyo (JP); Hidenori NAGAHAMA, Tokyo (JP); Yu SAITO, Tokyo (JP); Yasuki KIMURA, Tokyo (JP); Shuhei NIIKURA, Tokyo (JP)

(73) Assignees: Mitsubishi Electric Corporation, Tokyo (JP); Mitsubishi Electric Building Solutions Corporation, Tokyo (JP)

(21) Appl. No.: 19/150,543

(22) PCT Filed: Nov. 15, 2023
(86) PCT No.: PCT/JP2023/041145

§ 371 Date: Jul. 24, 2025

(30) Foreign Application Priority Data
Apr. 5, 2023 (WO) PCT/JP2023/014140

(51) Int. Cl. G01M 13/045; F16C 19/00

(52) U.S. Cl. CPC G01M 13/045; F16C 19/00; F16C 2233/00

(57) ABSTRACT

The diagnostic device includes a behavior sensor, a calculation unit, and a diagnosis unit. The behavior sensor is provided at an inner ring or an outer ring of the rolling bearing or a housing. The calculation unit calculates an evaluation speed based on information acquired by the behavior sensor. The evaluation speed is a maximum speed component in a direction in which a load from a rotation shaft acts within a period longer than a cycle of characteristic vibration determined by specifications of the rolling bearing, and a relative rotation speed of the inner ring and the outer ring. The diagnosis unit diagnoses damage to the rolling bearing by using an evaluation index based on the evaluation speed and the relative rotation speed.

### TECHNICAL FIELD

The present disclosure relates to an elevator traction machine, a rolling bearing, and a diagnostic device of the rolling bearing.

### BACKGROUND ART

PTL 1 discloses an example of a diagnostic device of a rolling bearing. The diagnostic device includes a vibration sensor and a damage and deterioration diagnosis unit. The vibration sensor is attached in contact with an inner ring or an outer ring of a rolling bearing or a housing that holds the inner ring or the outer ring. The damage and deterioration diagnosis unit diagnoses damage or deterioration of the rolling bearing based on an amplitude of an output signal from the vibration sensor.

### CITATION LIST

### Patent Literature

[PTL 1] JP S61-61055 A

### SUMMARY OF THE INVENTION

### Problem to be Solved by the Invention

The diagnostic device of PTL 1 performs diagnosis using converted impact values obtained by converting an impact value measured at the vibration sensor into a value in a case where a bearing diameter is a predetermined reference bearing diameter and a value in a case where a rotation speed is a predetermined reference rotation speed. On the other hand, the impact value is greatly affected by a shape of a damaged corner portion of the rolling bearing, and thus, there is a possibility that the diagnostic device cannot diagnose a size of the damage itself with high accuracy.

The present disclosure solves such a problem. The present disclosure provides an elevator traction machine, a rolling bearing and a diagnostic device of the rolling bearing that can further improve diagnosis accuracy of damage.

### Means to Solve the Problem

A diagnostic device according to the present disclosure is the diagnostic device that diagnoses a rolling bearing which includes an inner ring, an outer ring arranged concentrically with the inner ring, and a plurality of rolling elements arranged between a raceway surface of the outer ring and a raceway surface of the inner ring, and each rolling in association with rotation of the inner ring or rotation of the outer ring, wherein the diagnostic device includes a behavior sensor that is provided at the inner ring, the outer ring or a housing that holds the inner ring or the outer ring and measures behavior of the rolling bearing, a calculation unit that calculates an evaluation speed based on information acquired by the behavior sensor, the evaluation speed being a maximum speed component in a direction of a load acting on the rolling bearing from a rotation shaft that rotates in an integrated manner with the inner ring or the outer ring within a period equal to or longer than a cycle of characteristic vibration determined by specifications of the rolling bearing and a relative rotation speed of the inner ring and the outer ring, and a diagnosis unit that diagnoses damage to the rolling bearing by using an evaluation index based on the evaluation speed and the relative rotation speed.

A rolling bearing according to the present disclosure includes an inner ring, an outer ring arranged concentrically with the inner ring, a plurality of rolling elements arranged between a raceway surface of the outer ring and a raceway surface of the inner ring and each rolling in association with rotation of the inner ring or rotation of the outer ring, and the above-mentioned diagnostic device.

An elevator traction machine according to the present disclosure includes a rolling bearing including an inner ring, an outer ring arranged concentrically with the inner ring, a plurality of rolling elements arranged between a raceway surface of the outer ring and a raceway surface of the inner ring and each rolling in association with rotation of the inner ring or rotation of the outer ring, and the above-mentioned diagnostic device, a sheave; a rotation shaft that rotates in an integrated manner with part of the sheave and the rolling bearing, and a motor that rotates the rotation shaft.

### Advantageous Effects of the Invention

According to the elevator traction machine, the rolling bearing or the diagnostic device of the rolling bearing according to the present disclosure, it is possible to further improve diagnosis accuracy of damage.

### BRIEF DESCRIPTION OF DRAWINGS

FIG. 1 is a configuration diagram of a rolling bearing according to a first embodiment.

FIG. 2 is a diagram for explaining an example of diagnosis of damage to the rolling bearing by a diagnostic device according to the first embodiment.

FIG. 3 is a diagram for explaining another example of diagnosis of damage to the rolling bearing by the diagnostic device according to the first embodiment.

FIG. 4 is a configuration diagram of a rolling bearing according to a second embodiment.

FIG. 5 is a diagram for explaining an example of diagnosis of damage to a rolling bearing by a diagnostic device according to a third embodiment.

FIG. 6 is a configuration diagram of a rolling bearing according to a seventh embodiment.

FIG. 7 is a configuration diagram of a rolling bearing according to a ninth embodiment.

FIG. 8 is a diagram for explaining an example of diagnosis of damage to the rolling bearing by a diagnostic device according to the ninth embodiment.

FIG. 9 is a diagram for explaining an example of behavior when a rolling element of the rolling bearing according to the ninth embodiment passes through a damaged portion.

FIG. 10 is a diagram for explaining an example of diagnosis of damage to a rolling bearing by a diagnostic device according to a sixteenth embodiment.

FIG. 11 is a configuration diagram of a rolling bearing according to a nineteenth embodiment.

FIG. 12 is a configuration diagram of a rolling bearing according to a twentieth embodiment.

FIG. 13 is a diagram illustrating an example of a hardware configuration of a control unit of the diagnostic device according to any one of the first to the twenty-first embodiments.

FIG. 14 is a configuration diagram of an elevator traction machine according to a twenty-second embodiment.

### DESCRIPTION OF EMBODIMENTS

Modes for carrying out the subject of the present disclosure will be described with reference to the accompanying drawings. In respective drawings, the same or corresponding portions are denoted by the same reference numerals, and redundant description will be simplified or omitted as appropriate.

### First Embodiment

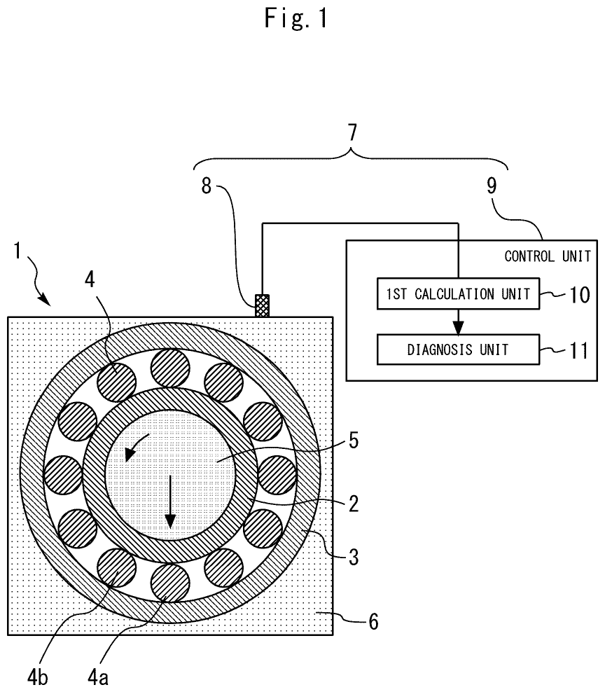

FIG. 1 is a configuration diagram of a rolling bearing according to a first embodiment.

A rolling bearing 1 includes an inner ring 2, an outer ring 3, a plurality of rolling elements 4, and a rotation shaft 5. In FIG. 1, a section of the rolling bearing 1 along a plane perpendicular to a shaft core of the rotation shaft 5 is illustrated. The inner ring 2 has a cylindrical shape. The outer ring 3 has a cylindrical shape. The outer ring 3 is arranged concentrically with the inner ring 2 outside the inner ring 2. The plurality of rolling elements 4 is arranged between the inner ring 2 and the outer ring 3. Each of the rolling elements 4 has a rollable shape such as a spherical shape or a columnar shape. The rolling elements 4 are arranged between a raceway surface that is an inner peripheral surface of the outer ring 3 and a raceway surface that is an outer peripheral surface of the inner ring 2. The rolling elements 4 roll in association with rotation of the inner ring 2, rotation of the outer ring 3 or rotation of both the inner ring 2 and the outer ring 3. Here, in a case where individual rolling elements 4 are distinguished from each other, one of the plurality of rolling elements 4 may be described as a rolling element 4a, a rolling element 4b, or the like.

The rotation shaft 5 rotates in an integrated manner with the inner ring 2 or the outer ring 3. The rotation shaft 5 in this example rotates counterclockwise on paper in FIG. 1. Here, a shaft direction along the shaft core of the rotation shaft 5, that is, an extending direction of the rotation shaft 5 may be simply referred to as a shaft direction. Further, a circumferential direction around the shaft core of the rotation shaft 5, that is, a rotation direction of the rotation shaft 5 may be simply referred to as a circumferential direction. Still further, a direction toward an outside of the rotation shaft 5 from the shaft core of the rotation shaft 5 may be simply referred to as a radial direction.

In the rolling bearing 1 in this example, the inner ring 2 rotates in an integrated manner with the rotation shaft 5, and the outer ring 3 is fixed. Note that in the rolling bearing 1, the outer ring 3 may rotate in an integrated manner with the rotation shaft 5, and the inner ring 2 may be fixed. Further, the rolling bearing 1 may be configured so that both the inner ring 2 and the outer ring 3 rotate.

The rolling bearing 1 is held in a housing 6. The housing 6 holds the inner ring 2 or the outer ring 3 of the rolling bearing 1.

In the rolling bearing 1, a diagnostic device 7 is applied. The diagnostic device 7 has a function of diagnosing a condition of damage, and the like, of the rolling bearing 1. The diagnostic device 7 may be a device included as part of rotation equipment such as a motor, in which the rolling bearing 1 is provided, or may be an external device to be externally applied to the rotation equipment. The diagnostic device 7 may be a device provided all the time in the rolling bearing 1 or rotation equipment in which the rolling bearing 1 is provided or may be a device temporarily provided as a portable device in the rolling bearing 1 or the rotation equipment in which the rolling bearing 1 is provided. The diagnostic device 7 includes a behavior sensor 8 and a control unit 9.

The behavior sensor 8 is attached to the housing 6. The behavior sensor 8 is a sensor that measures behavior of the housing 6. The behavior sensor 8 is, for example, an acceleration sensor, a displacement sensor, a speed sensor, or the like.

The control unit 9 has a function of performing data processing in the diagnostic device 7. The control unit 9 may include one or more pieces of independent hardware or may be part of other hardware such as control equipment of the rotation equipment in which the rolling bearing 1 is provided. The control unit 9 includes a first calculation unit 10 and a diagnosis unit 11.

The first calculation unit 10 is a portion having a function of calculating an evaluation speed to be used for diagnosis of the rolling bearing 1. The evaluation speed is calculated for a period equal to or longer than a cycle Tr of characteristic vibration determined by specifications of the rolling bearing 1. The evaluation speed is a total value of a maximum speed component in a direction in which a load from the rotation shaft 5 acts, and a maximum speed component in a direction opposite to the direction in which the load from the rotation shaft 5 acts within the period. The direction in which the load from the rotation shaft 5 acts is, for example, an outward direction in the radial direction or a downward direction in a vertical direction. In this event, the direction opposite to the direction in which the load from the rotation shaft 5 acts is an inward direction in the radial direction or an upward direction in the vertical direction. Here, the direction in which the load from the rotation shaft 5 acts and the direction opposite to the direction in which the load from the rotation shaft 5 acts may be respectively expressed as a load direction and an anti-load direction.

The first calculation unit 10 calculates the evaluation speed by processing an output signal from the behavior sensor 8. For example, in a case where the behavior sensor 8 is a speed sensor, the first calculation unit 10 calculates the evaluation speed using time-series data of a speed that is the output signal from the behavior sensor 8. Further, in a case where the behavior sensor 8 is an acceleration sensor, the first calculation unit 10 performs time integration on time-series data of an acceleration that is the output signal from the behavior sensor 8 to calculate time-series data of the speed. In this event, the first calculation unit 10 calculates the evaluation speed using the calculated time-series data of the speed. Further, in a case where the behavior sensor 8 is a displacement sensor, the first calculation unit 10 differentiates with respect to time, time-series data of a displacement that is the output signal from the behavior sensor 8 to calculate time-series data of the speed. In this event, the first calculation unit 10 calculates the evaluation speed using the calculated time-series data of the speed.

The first calculation unit 10 calculates a maximum speed component in the direction in which the load from the rotation shaft 5 acts from the time-series data of the speed for a period set in advance, equal to or longer than a cycle Tr. The first calculation unit 10 calculates a maximum speed component in the direction opposite to the direction in which the load from the rotation shaft 5 acts from the time-serries data of the speed for the period. The first calculation unit 10 calculates the evaluation speed by adding absolute values of these two maximum speed components.

The diagnosis unit 11 is a portion having a function of diagnosing damage to the rolling bearing 1 by using an evaluation index based on the evaluation speed calculated by the first calculation unit 10. In this example, the diagnosis unit 11 diagnoses the damage to the rolling bearing 1 using the evaluation speed itself calculated by the first calculation unit 10 as the evaluation index. The diagnosis unit 11, for example, provides a diagnose that damage has occurred to the rolling bearing 1 in a case where the evaluation speed exceeds a threshold set in advance.

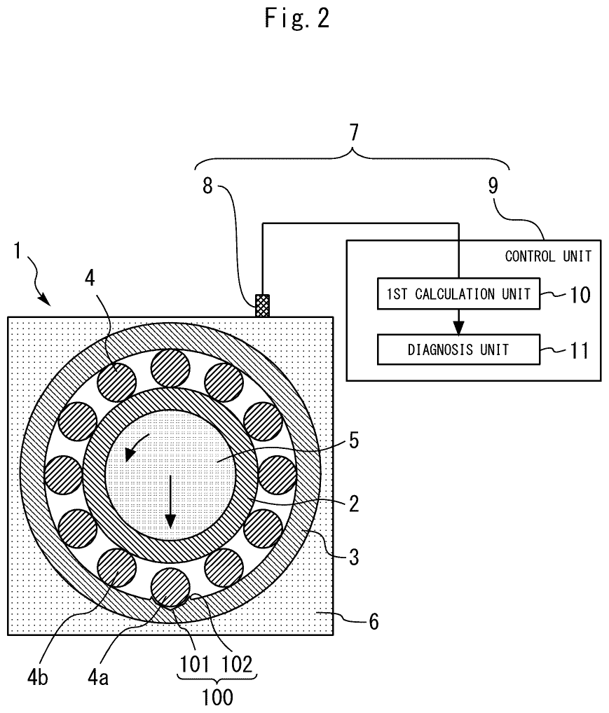

Subsequently, an example of diagnosis of damage to the rolling bearing 1 by the diagnostic device 7 will be described using FIG. 2.

FIG. 2 is a diagram for explaining an example of diagnosis of the damage to the rolling bearing by the diagnostic device according to the first embodiment.

In FIG. 2, a damaged portion 100 is illustrated as an example of damage that can occur to the rolling bearing 1. The damaged portion 100 occurs in the rolling bearing 1, for example, as follows.

In the rolling bearing 1 in this example, the rotation shaft 5 rotates counterclockwise on paper in an integrated manner with the inner ring 2. In this event, each rolling element 4 in contact with the raceway surface of the inner ring 2 rotationally moves so as to revolve around a central axis of the rotation shaft 5 between the inner ring 2 and the outer ring 3 counterclockwise on paper while rotating around a central point of the rolling element 4 itself clockwise on paper in association with rotation of the inner ring 2. In a case where a load on the inner ring 2 due to a load, and the like, of the rotation shaft 5 acts in a lower part on paper, most of the load from the rotation shaft 5 is transmitted to the raceway surface of the inner ring 2, and the raceway surface of the outer ring 3 via the plurality of rolling elements 4, and the like, located below the rotation shaft 5. When the rotation shaft 5 stands still, a position and a magnitude of load occurring in each of the inner ring 2, the outer ring 3 and the rolling elements 4 do not change. On the other hand, when the rotation shaft 5 rotates, the position and the magnitude of the load periodically change in association with rotational movement of the inner ring 2 and the rolling elements 4. By this means, repetitive stress loads act on the raceway surfaces of the inner ring 2 and the outer ring 3. Due to such repetitive stress loads, for example, a crack which originates from impurities inside a material, may make progress from an inside of the inner ring 2, the outer ring 3, or the like, and reach a surface. In this event, an internally-originating flaking-off damage that is scalelike flaking off of a surface zone can occur on the raceway surface, or the like, of the inner ring 2 or the outer ring 3.

Further, abnormal slipping may occur between the rolling element 4, and the inner ring 2 and the outer ring 3 due to poor lubrication of the raceway surface caused by insufficient greasing of a lubricant such as grease, deterioration, leak, insufficient viscosity, an excessive load, or the like. In this event, stress is likely to concentrate on a surface of the raceway surface due to rough surface, wear, or the like, of the raceway surface, and damage to the raceway surface may be further accelerated. As an example, a surface-originating flaking-off damage which is scalelike flaking off of a surface zone of part of the raceway surface, a wear damage, or the like, may occur on the raceway surface.

Concerning the internally-originating flaking-off damage, there is a lifespan design formula called L10 life, and specifications of the rolling bearing 1 are normally determined based on the lifespan design formula, and thus, the internally-originating flaking-off damage hardly occurs. On the other hand, the surface-originating flaking-off damage can occur extremely earlier than the internally-originating flaking-off damage, and thus, it is important to diagnose a condition of the rotation equipment to secure reliability and achieve long-term operation of the rolling bearing 1 and the rotation equipment in which the rolling bearing 1 is provided.

According to the knowledge obtained from a bearing test, the damaged portion 100 by the flaking-off damage is often formed on the raceway surface of the rolling bearing 1. Further, the damaged portion 100 is often constituted of a recessed portion 101 and a damaged corner portion 102. It is considered that sizes and shapes of the recessed portion 101 and the damaged corner portion 102 are always changing in accordance with a total number of rotations of the rolling bearing 1. Further, the recessed portion 101 becomes larger as the total number of rotations of the rolling bearing 1 increases. On the other hand, it has been confirmed that the shape of the damaged corner portion 102 is sharp in an initial stage of occurrence of the damage, but thereafter, may change to a smooth shape by wear, and the like. In a case where the damaged portion 100 is caused by the surface-originating flaking-off damage, a depth of the recessed portion 101 is shallow in an initial stage of occurrence of the damage, and thus, the recessed portion 101 becomes larger in a shaft direction and in a circumferential direction and also becomes deeper in a radial direction during progress of the damage.

While instantaneous vibration increases as a result of the shape of the damaged corner portion 102 becoming sharp, lifespans of rolling bearing 1 and the rotation equipment in which the rolling bearing 1 is provided are less affected. On the other hand, the recessed portion 101 becomes larger as the total number of rotations of the rolling bearing 1 increases, which can lead to continuous increase, and the like, of rattling, wobble or abnormal noise of the rolling bearing 1 and the whole rotation equipment in which the rolling bearing 1 is provided. Thus, the size of the recessed portion 101 can largely affect the lifespans of the rolling bearing 1 and the whole rotation equipment in which the rolling bearing 1 is provided.

For example, as illustrated in FIG. 1, consideration will be given to a case where in the inner-ring-rotation-type rolling bearing 1 in which the inner ring 2 rotates along with the rotation shaft 5, the recessed portion 101 is formed on a load side of the outer ring 3. If the recessed portion 101 becomes larger, the rolling element 4 sinks down in the recessed portion 101 at a timing at which the rolling element 4 arrives at the recessed portion 101 upon rotation of the rolling bearing 1. In this event, the rolling element 4 drops in a depth direction of the recessed portion 101 along with the inner ring 2 and the rotation shaft 5. Further, the rolling element 4 rises from a bottom portion of the recessed portion 101 along with the inner ring 2 and the rotation shaft 5 at a timing at which the rolling element 4 goes out from the recessed portion 101. Thus, rattling, wobble and abnormal noise of the rolling bearing 1 and the rotation shaft 5 become larger as the recessed portion 101 is deeper. If the recessed portion 101 becomes too deep, rattling, wobble and abnormal noise of the rolling bearing 1 and the rotation shaft 5 may become extremely large. In this event, there is a case where a design upper limit of the rotation equipment in which the rolling bearing 1 is provided may be exceeded. Further, there is a case where this may lead to a failure such as a crack in or breakage of the rolling bearing 1, a failure of peripheral equipment of the rolling bearing 1, a failure of the whole rotation equipment in which the rolling bearing 1 is provided, and the like.

It is therefore important to diagnose a condition of a size or a degree of the damage to the rolling bearing 1, such as a depth of the recessed portion 101. By diagnosing the condition of the rolling bearing 1, it is possible to detect an abnormality in and estimate a remaining lifespan of the rolling bearing 1, and the like, and perform maintenance and lifespan extension treatment such as replacement of the rolling bearing 1 or grease at an appropriate timing. Further, this makes it possible to save labor of the maintenance and achieve long-term stable operation of the rolling bearing 1, the peripheral equipment of the rolling bearing 1, and the whole rotation equipment in which the rolling bearing 1 is provided.

The diagnostic device 7 diagnoses the damaged portion 100 as illustrated in FIG. 2, for example, as follows. Note that while a case where the damaged portion 100 has occurred in the outer ring 3 is illustrated as an example in FIG. 2, the damaged portion 100 may occur in the inner ring 2 or the rolling element 4.

The first calculation unit 10 calculates an evaluation speed for a period equal to or longer than the cycle Tr of the characteristic vibration determined by the specifications of the rolling bearing 1. The characteristic vibration described here includes not only vibration occurring when the rolling element 4 passes through the damaged portion 100 that has occurred in the outer ring 3 as illustrated in FIG. 2, but also vibration occurring when the rolling element 4 passes through the damaged portion 100 that has occurred in the inner ring 2, and vibration occurring when the inner ring 2 and the outer ring 3 pass through the damaged portion 100 that has occurred in the rolling element 4. Here, among the cycle Tr, a cycle of characteristic vibration originating from damage to the inner ring 2 is defined as Trᵢ [sec], a cycle of characteristic vibration originating from damage to the outer ring 3 is defined as Trₒ [sec], and a cycle of characteristic vibration originating from damage to the rolling element 4 is defined as Tr_{b} [sec]. In a case where damage has occurred to the inner ring 2, the characteristic vibration of the cycle Trᵢ is particularly large, in a case where damage has occurred to the outer ring 3, the characteristic vibration of the cycle Trₒ is particularly large, and in a case where damage has occurred to the rolling element 4, the characteristic vibration of the cycle Tr_{b} is particularly large. For example, in a case where the outer ring 3 has the damaged portion 100 as illustrated in FIG. 2, a period from when the rolling element 4a passes through the damaged portion 100 until when the rolling element 4b passes through the damaged portion 100 becomes the cycle Trₒ. For example, in a case where a diameter of the rolling element 4 is defined as d [mm], a revolution diameter of the rolling element 4 is defined as D [mm], the number of rolling elements 4 is defined as Z, a contact angle of the rolling element 4 is defined as a [rad], and a rotation frequency of the inner ring 2 is defined as fᵣ [rps], the cycle Trᵢ of the characteristic vibration originating from damage to the inner ring 2, the cycle Trₒ of the characteristic vibration originating from damage to the outer ring 3, and the cycle Tr_{b} of the characteristic vibration originating from damage to the rolling element 4 are respectively expressed with the following expression (1), expression (2) and expression (3).

$$[ Math . 1 ]$$

$${Tr}_{i} = \frac{2}{{f}_{r} Z} ( \frac{D}{D + d cos α} ) \qquad ( 1 )$$

$$[ Math . 2 ]$$

$${Tr}_{o} = \frac{2}{{f}_{r} Z} ( \frac{D}{D - d cos α} ) \qquad ( 2 )$$

$$[ Math . 3 ]$$

$${Tr}_{b} = \frac{2 d}{{f}_{r} D} ( \frac{{D}^{2}}{{D}^{2} - {d}^{2} {cos}^{2} α} ) \qquad ( 3 )$$

Regardless of a position where the damaged portion 100 has occurred among the inner ring 2, the outer ring 3 and the rolling element 4, behavior of any part sinking down and dropping in the recessed portion 101 of the damaged portion 100 and going out and rising from the recessed portion 101 occurs at least once within a period of the cycle Tr. The first calculation unit 10 calculates a maximum speed component in a direction in which the load from the rotation shaft 5 acts and a maximum speed component in an opposite direction thereof in the period equal to or longer than the cycle Tr using the time-series data of the speed based on the output signal from the behavior sensor 8. The first calculation unit 10 adds absolute values of the two maximum speed components to obtain the evaluation speed. As a result of the diagnosis unit 11 diagnosing damage to the rolling bearing 1 based on the evaluation speed obtained by the first calculation unit 10 in this manner, regardless of a position where the damaged portion 100 has occurred among the inner ring 2, the outer ring 3, and the rolling element 4, the diagnostic device 7 can diagnose a size or a degree of the damaged portion 100 with high accuracy.

Further, the diagnosis unit 11 can provide an abnormality diagnosis indicating that damage has occurred to the rolling bearing 1 in a case where the evaluation speed exceeds a threshold set in advance. Still further, the diagnosis unit 11 can diagnose a size or a degree of the damaged portion 100 such as a depth of the recessed portion 101 with high accuracy by diagnosis based on the evaluation speed.

As described above, the rolling bearing 1 according to the first embodiment includes the inner ring 2, the outer ring 3, the plurality of rolling elements 4, and the diagnostic device 7. The outer ring 3 is arranged concentrically with the inner ring 2. The plurality of rolling elements 4 is arranged between the raceway surface of the outer ring 3 and the raceway surface of the inner ring 2. Each of the rolling elements 4 rolls in association with rotation of the inner ring 2, rotation of the outer ring 3 or rotation of both the inner ring 2 and the outer ring 3. In the rolling bearing 1, the rotation shaft 5 rotates in an integrated manner with the inner ring 2 or the outer ring 3. The diagnostic device 7 includes the behavior sensor 8, the first calculation unit 10, and the diagnosis unit 11. The behavior sensor 8 is provided on the housing 6 that holds the inner ring 2 or the outer ring 3. The behavior sensor 8 measures behavior of the housing 6. The first calculation unit 10 calculates the evaluation speed based on information acquired by the behavior sensor 8. The evaluation speed is a total value of the maximum speed component in a direction in which the load from the rotation shaft 5 acts and the maximum speed component in a direction opposite to the direction in which the load from the rotation shaft 5 acts within a period equal to or longer than the cycle Tr of the characteristic vibration determined by the specifications of the rolling bearing 1. The diagnosis unit 11 diagnoses the damage to the rolling bearing 1 using the evaluation index based on the evaluation speed calculated by the first calculation unit 10.

As a comparative example, consideration will be given to a case where damage to the rolling bearing is diagnosed only based on an amplitude of the vibration of the output signal from the vibration sensor without depending on the evaluation index based on the evaluation speed, unlike with the diagnostic device 7. When the rolling element of the rolling bearing passes through the damaged portion, it is often the case that fine and small vibration occurs a plurality of times. Thus, even if the damaged portion becomes large, the amplitude of the vibration does not become large, and thus, there is a case where the damage cannot be diagnosed with high accuracy only based on the amplitude of the vibration. Further, if a shape of the damaged corner portion of the damaged portion becomes smooth by wear, and the like, the rolling element smoothly passes through the damaged portion, and thus, influence of the damaged portion does not appear in the amplitude of the vibration, and the damage is not detected. Still further, in a case where the shape of the damaged corner portion is sharp even if the recessed portion of the damaged portion is small, there is a case where an instantaneous behavior change may become large at a timing at which the rolling element passes through the damaged corner portion. In this event, vibration, and the like, in which acceleration, and the like, instantaneously increase alternately in the load direction and in the anti-load direction can occur. By this means, an amplitude of the acceleration, and the like, can become large regardless of the size of the recessed portion, and thus, it may be difficult to diagnose the size of the damage itself such as the size of the recessed portion of the damaged portion with high accuracy. Further, the vibration of the rolling bearing can include vibration in a high frequency band caused by friction sliding, and the like. Thus, a magnitude of the vibration can change depending on a lubricated condition of the rolling bearing. For example, if the lubricated condition is deteriorated due to oxidation deterioration of grease that lubricates the rolling bearing, oil separation, leak, destruction of a thickening agent, or the like, there is a case where the vibration increases several times even if damage does not occur to the rolling bearing itself. In this manner, the diagnosis only based on the magnitude of the amplitude of the vibration is affected by a change of the lubricated condition of the rolling bearing, and thus, there is a case where diagnosis accuracy of damage to the rolling bearing may degrade.

On the other hand, the diagnostic device 7 performs diagnosis using the evaluation speed that is a total value of the maximum speed component in the load direction at a timing at which the rolling element 4 sinks down in the recessed portion 101, and the maximum speed component in the anti-load direction at a timing at which the rolling element 4 goes out of the recessed portion 101. Instantaneous behavior occurring when the rolling element 4 passes through the damaged corner portion 102 appears as an instantaneous acceleration amplitude. A speed obtained by integrating such an instantaneous acceleration amplitude hardly becomes large and is relatively smaller than speeds at a timing at which the rolling element 4 sinks down in the recessed portion 101 and at a timing at which the rolling element 4 goes out of the recessed portion 101. Diagnosis is performed using the evaluation speed that is a total value of these speeds, and thus, the diagnostic device 7 can suppress influence of instantaneous behavior of the rolling element 4 by the shape of the damaged corner portion 102 upon diagnosis. Further, both the maximum speed component in the load direction and the maximum speed component in the anti-load direction become larger as the depth of the recessed portion 101 is larger. The diagnostic device 7 that uses the evaluation speed having a strong correlation with the depth of the recessed portion 101 can diagnose the depth of the recessed portion 101 with high accuracy. Further, the evaluation speed becomes large by a geometric shape of the recessed portion 101, and thus, unlike with a device that performs diagnosis based on vibration including a high frequency band caused by friction sliding, the diagnostic device 7 can diagnose the damage to the rolling bearing 1 with high accuracy while suppressing influence of the lubricated condition.

Further, typically, the rolling bearing is a portion to which the largest load is applied in the rotation equipment and that is likely to break down first. If damage occurs to the rolling bearing, there is a case where the damage may become large at an accelerated rate as a result of stress around the damage becoming large. If the damage becomes large, there is a possibility that breakage of the rolling bearing, damage to or breakage of peripheral equipment of the rolling bearing, a severe failure of the whole rotation equipment in which the rolling bearing is provided, and the like, may occur.

Concerning this, the diagnostic device 7 can diagnose the damage to the rolling bearing 1 with high accuracy, so that it is possible to perform preventive maintenance of the rolling bearing 1. This makes it possible to prevent in advance a failure not only in the rolling bearing 1 itself but also in peripheral equipment of the rolling bearing 1 and the whole rotation equipment in which the rolling bearing 1 is provided.

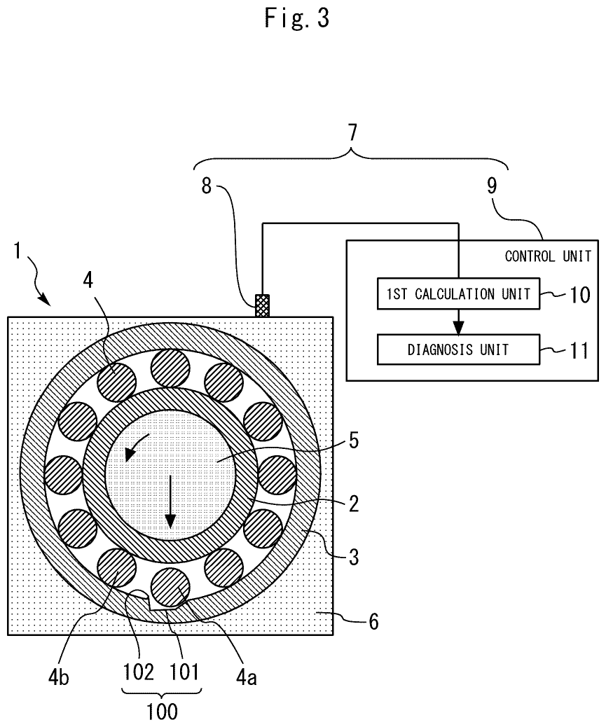

FIG. 3 is a diagram for explaining another example of diagnosis of the damage to the rolling bearing by the diagnostic device according to the first embodiment.

FIG. 3 illustrates the damaged portion 100 having the recessed portion 101 asymmetric in the circumferential direction as another example of the damage that can occur to the rolling bearing 1.

There is a case where in such a damaged portion 100, the maximum speed component in the load direction and the maximum speed component in the anti-load direction are different depending on the rotation direction of the rotation shaft 5. Also in this case, the diagnostic device 7 can diagnose the damage to the rolling bearing 1 with high accuracy regardless of the rotation direction by performing diagnosis using the evaluation speed that is a total value of the maximum speed component in the load direction and the maximum speed component in the anti-load direction. For example, as illustrated in FIG. 3, in the rolling bearing 1 in which the inner ring 2 rotates counterclockwise on paper along with the rotation shaft 5, there is a case where a side opposite to a traveling direction of the rotation direction of the recessed portion 101 of the damaged portion 100 is inclined more sharply than a side of the traveling direction of the rotation direction. In this case, compared to the damaged portion 100 symmetric in the circumferential direction, the maximum speed component in the load direction may become large at a timing at which the rolling element 4 sinks down in the recessed portion 101, and the maximum speed component in the anti-load direction may become small at a timing at which the rolling element 4 goes out of the recessed portion 101. Further, in a case where the rotation shaft 5 rotates backward, the maximum speed component in the load direction may become small at a timing at which the rolling element 4 sinks down in the recessed portion 101, and the maximum speed component in the anti-load direction may become large at a timing at which the rolling element 4 goes out of the recessed portion 101. In other words, there is a case where the maximum speed component in the load direction and the maximum speed component in the anti-load direction may be different from each other in magnitude depending on the rotation direction of the rotation shaft 5 for the same recessed portion 101. On the other hand, a magnitude of the evaluation speed that is a total value of the maximum speed component in the load direction and the maximum speed component in the anti-load direction does not largely change depending on the rotation direction. The diagnostic device 7 performs diagnosis using the evaluation speed, and thus, can diagnose the damage to the rolling bearing 1 with higher accuracy while suppressing influence of the rotation direction of the rotation shaft 5. Particularly, in the rolling bearing 1 to be applied to rotation equipment such as, for example, an elevator, a railroad vehicle, and a generator rotating in both directions, in which the rotation direction can change, the diagnostic device 7 exerts a function capable of performing diagnosis without being affected by the rotation direction more effectively.

In each of embodiments which will be described below, differences from examples disclosed in other embodiments will be particularly described in detail. Concerning features not described in each of the embodiments described below, any features in the examples disclosed in other embodiments may be employed.

### Second Embodiment

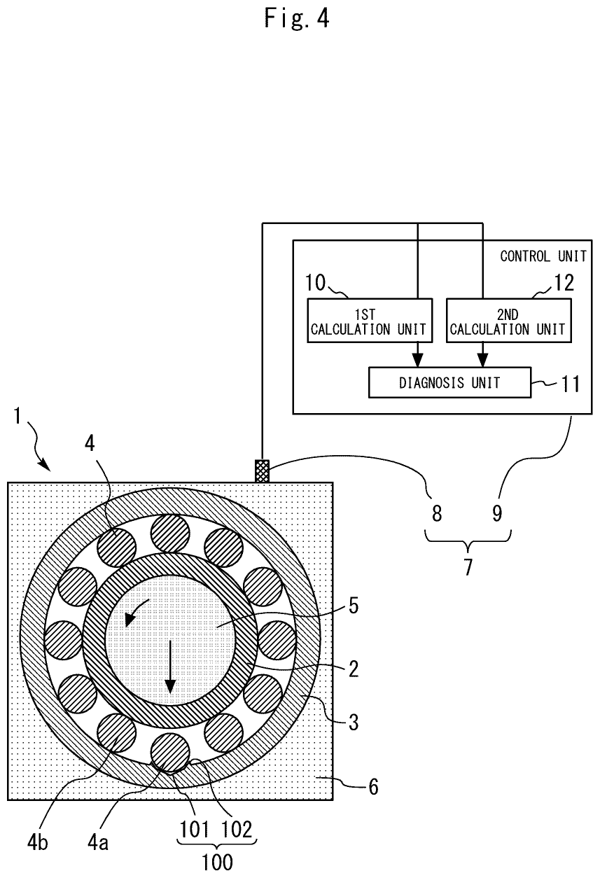

FIG. 4 is a configuration diagram of a rolling bearing according to a second embodiment.

The control unit 9 of the diagnostic device 7 of the rolling bearing 1 includes the first calculation unit 10, a second calculation unit 12, and the diagnosis unit 11.

The second calculation unit 12 is a portion having a function of calculating an acceleration frequency spectrum, an acceleration overall value or both of them based on the information acquired by the behavior sensor 8.

The second calculation unit 12 calculates the acceleration frequency spectrum, the acceleration overall value or both of them by processing the output signal from the behavior sensor 8. For example, in a case where the behavior sensor 8 is an acceleration sensor, the second calculation unit 12 calculates the acceleration frequency spectrum, the acceleration overall value or both of them using time-series data of an acceleration that is the output signal from the behavior sensor 8. Further, in a case where the behavior sensor 8 is a speed sensor, the second calculation unit 12 may differentiate with respect to time, time-series data of a speed that is the output signal from the behavior sensor 8 to calculate time-series data of the acceleration. In this event, the second calculation unit 12 calculates the acceleration frequency spectrum, the acceleration overall value or both of them using the calculated time-series data of the acceleration. Further, in a case where the behavior sensor 8 is a displacement sensor, the second calculation unit 12 may differentiate with respect to time, time-series data of a displacement that is the output signal from the behavior sensor 8 twice to calculate time-series data of the acceleration. In this event, the second calculation unit 12 calculates the acceleration frequency spectrum, the acceleration overall value or both of them using the calculated time-series data of the acceleration. The second calculation unit 12 may calculate the acceleration frequency spectrum, the acceleration overall value or both of them, for example, for a period equal to or longer than the cycle Tr for which the evaluation speed is calculated by the first calculation unit 10 or may calculate the acceleration frequency spectrum, the acceleration overall value or both of them for a longer or shorter period.

The acceleration frequency spectrum is a magnitude of an acceleration amplitude spectrum obtained for each frequency band by performing calculation such as Fourie transform on the time-series data of the acceleration acquired using the behavior sensor 8.

The evaluation vibration is an evaluation index calculated based on both the evaluation speed and the acceleration frequency spectrum, and thus, an occurrence position of the damaged portion 100 may be able to be determined as well as the size of the damaged portion 100 is able to be diagnosed with higher accuracy. In particular, use of the acceleration amplitude spectrum in the frequency band of the characteristic vibration, which is an inverse of the cycle of the characteristic vibration of the rolling bearing, makes it possible to grasp characteristic vibration originating from the damage, and the like, in detail for each occurrence position of the damaged portion 100 such as the inner ring 2, the outer ring 3 or the rolling element 4. This enables the diagnosis unit 11 to determine a position among the inner ring 2, the outer ring 3 or the rolling element 4 of the rolling bearing 1, where the damaged portion 100 has occurred. Further, the diagnosis unit 11 can diagnosis the size of the damaged portion 100 with high accuracy using information regarding a magnitude of the acceleration amplitude spectrum in the frequency band of the characteristic vibration.

The acceleration overall value is an integrated value of magnitudes of the whole acceleration frequency spectra regardless of the frequency band for information such as the time-series data, and the like, acquired by the behavior sensor 8.

In a case where a minor damage such as wear or rough surface has occurred to the raceway surface, or the like, on which the rolling element 4 rolls, the rolling element 4 hardly sinks down in or goes out of the recessed portion 101. In this event, a rise range of the evaluation speed becomes small. On the other hand, the acceleration overall value is an integrated value of the magnitudes of the whole acceleration frequency spectra regardless of the frequency band, and thus, it considerably rises also by minor wear, rough surface, or the like. The evaluation vibration is an evaluation index calculated based on both the evaluation speed and the acceleration overall value, and thus, the diagnostic device 7 can also diagnose a minor damage such as wear and rough surface with high accuracy.

As described above, the diagnosis unit 11 calculates the evaluation vibration as the evaluation index using the evaluation speed calculated by the first calculation unit 10, and the acceleration frequency spectrum calculated by the second calculation unit 12, the acceleration overall value, or both of them. Further, the diagnosis unit 11, for example, calculates the evaluation vibration by multiplying each of the evaluation speed, and the acceleration frequency spectrum, the acceleration overall value or both of them by a weighting coefficient and adding up the results. Further, the diagnosis unit 11 may, for example, calculate the evaluation vibration by an arithmetic average, a geometric mean or other functions of the evaluation speed, and the acceleration frequency spectrum, the acceleration overall value or both of them. The diagnosis unit 11, for example, provides a diagnosis indicating that damage has occurred to the rolling bearing 1 in a case where the evaluation vibration exceeds a threshold set in advance. Here, the weighting coefficient and the function are determined in advance, for example, using a data analysis method such as regression analysis or a machine learning method which uses as input, data of the evaluation speed, and the acceleration frequency spectrum, the acceleration overall value or both of them calculated for a plurality of rolling bearings 1 for which the size of the damage is known. As a result of the weighting coefficient and the function being determined using the information on the rolling bearings 1 for which the size of the damage is known, a correlation between the evaluation vibration and the size and the occurrence position of the damage becomes strong. This further improves diagnosis accuracy of the damage to the rolling bearing 1 using the evaluation vibration as the evaluation index.

### Third Embodiment

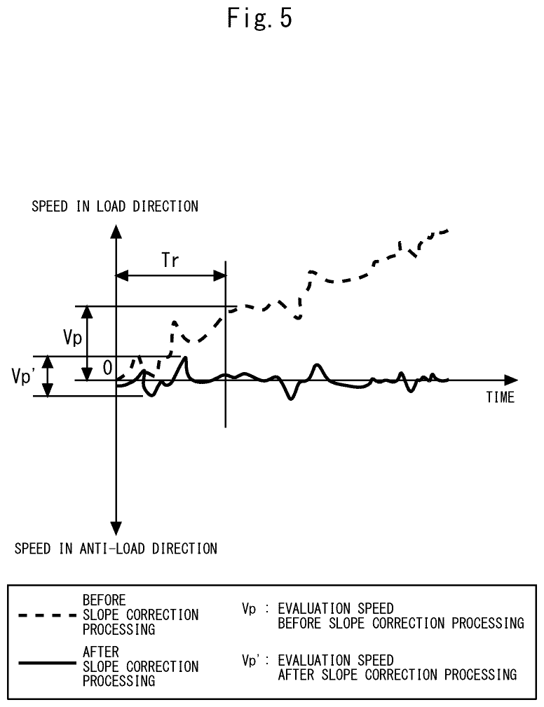

FIG. 5 is a diagram for explaining an example of diagnosis of damage to a rolling bearing by a diagnostic device according to a third embodiment.

FIG. 5 indicates transition of time on a horizontal axis. FIG. 5 indicates a speed acquired by the behavior sensor 8 on a vertical axis. An upper side on the vertical axis indicates the magnitude of a speed in the load direction. On the other hand, a lower side on the vertical axis indicates the magnitude of a speed in the anti-load direction.

For example, in a case where the time-series data of the speed is calculated by performing time integration on the time-series data of the acceleration using the acceleration sensor as the behavior sensor 8, as indicated by a dashed line in FIG. 5, the speed may extremely increase in the load direction over a period equal to or longer than the cycle Tr. This occurs as a result of the time-series data of the acceleration which is the output signal being wholly shifted in the load direction in a case where an attachment condition of the behavior sensor 8 that is the acceleration sensor is poor, in a case where noise such as other turbulence vibration is greatly reflected, or the like. For a similar reason, the speed may increase in the anti-load direction over a period equal to or longer than the cycle Tr.

On the other hand, even if there is a case where minor vibration may occur in the rolling bearing 1 and the housing 6, normally, installation positions of the rolling bearing 1 and the housing 6 do not largely change. Thus, a condition where the speed continues to increase for a long period as indicated by the dashed line in FIG. 5 is different from an actual condition, and if such time-series data is used as is, an evaluation speed Vp is calculated as an excessive value. Thus, the diagnostic device 7 performs slope correction on the time-series data of the speed.

The first calculation unit 10 of the diagnostic device 7 performs slope correction processing on the time-series data of the speed based on the information acquired by the behavior sensor 8. The slope correction processing is performed, for example, by obtaining a slope component of the time-series data of the speed through linear regression or other methods over a period equal to or longer than the cycle Tr and subtracting the obtained slope component from the time-series data of the speed. The first calculation unit 10 calculates an evaluation speed Vp′ for the period equal to or longer than the cycle Tr using the time-series data of the speed subjected to the slope correction processing.

The diagnostic device 7 can diagnose the damage to the rolling bearing 1 without being affected by an attachment condition of the behavior sensor 8 and noise such as turbulence vibration by using the evaluation speed Vp′ calculated in this manner.

### Fourth Embodiment

The first calculation unit 10 of the diagnostic device 7 performs frequency filter processing on the time-series data based on the information acquired by the behavior sensor 8. The first calculation unit 10 performs frequency filter processing on the time-series data of, for example, the acceleration, the speed or the displacement acquired by the behavior sensor 8. The first calculation unit 10 may perform frequency filter processing on the time-series data of the speed derived from the time-series data of the acceleration or the displacement acquired by the behavior sensor 8. Further, the first calculation unit 10 may perform frequency filter processing on both the time-series data acquired by the behavior sensor 8 and the time-series data of the speed derived from the time-series data. The frequency filter processing is, for example, high-pass filter, low-pass filter, bandpass filter or other kinds of filter processing. The first calculation unit 10 calculates the evaluation speed for the period equal to or longer than the cycle Tr using the time-series data of the speed subjected to the frequency filter processing.

Use of the evaluation speed calculated in this manner enables the diagnostic device 7 to diagnose the damage to the rolling bearing 1 without being affected by vibration in a low frequency caused by beats, and the like, vibration in a high frequency caused by friction, and the like, noise, turbulence vibration, and the like.

### Fifth Embodiment

The diagnosis unit 11 of the diagnostic device 7 diagnoses the damage to the rolling bearing 1 by using an evaluation index statistic obtained by performing statistical processing on a data group of evaluation indexes such as the evaluation speeds or the evaluation vibration calculated over a plurality of times. The evaluation index statistic is, for example, an average value, a median value, an effective value or a maximum value for the data group of the evaluation indexes. The diagnosis unit 11 provides a diagnosis indicating that damage has occurred to the rolling bearing 1, for example, in a case where the evaluation index statistic exceeds a threshold set in advance.

Each evaluation index such as an evaluation speed or evaluation vibration of each time calculated by the first calculation unit 10, and the like, may take an extremely large value as a result of, for example, the behavior sensor 8 capturing unexpected turbulence vibration, or the like, which is irrelevant to the damage of the rolling bearing 1. Concerning this, the diagnosis unit 11 performs diagnosis using the evaluation index statistic such as the average value, the median value, the effective value, and the like, obtained by performing statistical processing on the data group of the evaluation indexes, and thus, the diagnostic device 7 can perform diagnosis without being affected by an unexpected event that is irrelevant to the damage of the rolling bearing 1.

Further, for example, the evaluation index such as the evaluation speed and the evaluation vibration may become large with low frequency in a stage in which the damage of the rolling bearing 1 is small. Concerning this, the diagnosis unit 11 performs diagnosis using the evaluation index statistic such as the maximum value obtained by performing statistical processing on the data group of the evaluation indexes, and thus, the diagnostic device 7 can diagnose occurrence of the damage in a small stage earlier.

Further, for example, the evaluation index such as the evaluation speed and the evaluation vibration may rapidly change in a condition where the damage of the rolling bearing 1 rapidly progresses. Concerning this, the diagnosis unit 11 performs diagnosis using the evaluation index statistic such as a standard deviation value or a variance value obtained by performing statistical processing on the data group of the evaluation indexes, and thus, the diagnostic device 7 can further diagnose a progress condition of the damage.

### Sixth Embodiment

The diagnosis unit 11 of the diagnostic device 7 diagnoses the damage to the rolling bearing 1 based on a cyclic change of the evaluation index such as the evaluation speed or the evaluation vibration which is continuously calculated to obtain temporally successive evaluation speeds or evaluation vibration.

For example, in the time-series data of the evaluation index calculated by the diagnosis unit 11, and the like, the evaluation index becomes large at a timing at which the rolling element 4 passes through the damaged portion 100 and substantially coincides with the cycle Tr of the characteristic vibration determined by the specifications of the rolling bearing 1. On the other hand, the cycle of the rolling element 4 passing through the damaged portion 100 is determined by expression (1) to expression (3) using a position where the damaged portion 100 has occurred, a dimension of the rolling bearing 1, a rotation speed of the rotation shaft 5, and the like. Thus, the diagnosis unit 11 can determine a position among the inner ring 2, the outer ring 3 or the rolling element 4 of the rolling bearing 1, where the damaged portion 100 has occurred from the cycle, the frequency, or the like, in which the evaluation index becomes large, based on the dimension and the rotation speed of the rolling bearing 1.

Further, the diagnosis unit 11 may diagnose the size of the damaged portion 100 based on the evaluation index in the cycle in which the evaluation index becomes large. This enables the diagnosis unit 11 to diagnose the size of the damaged portion 100 with high accuracy without being affected by noise such as turbulence vibration, and the like. The diagnosis unit 11 may, for example, diagnose a position where the damaged portion 100 has occurred from a frequency band in which the spectrum is large for frequency analysis data obtained by performing frequency analysis on the time-series data of the evaluation index. The diagnosis unit 11 can diagnose the size of the damaged portion 100 with high accuracy without being affected by noise such as turbulence vibration, for example, by diagnosing the size of the damaged portion 100 from a magnitude of the spectrum in a specific frequency band.

### Seventh Embodiment

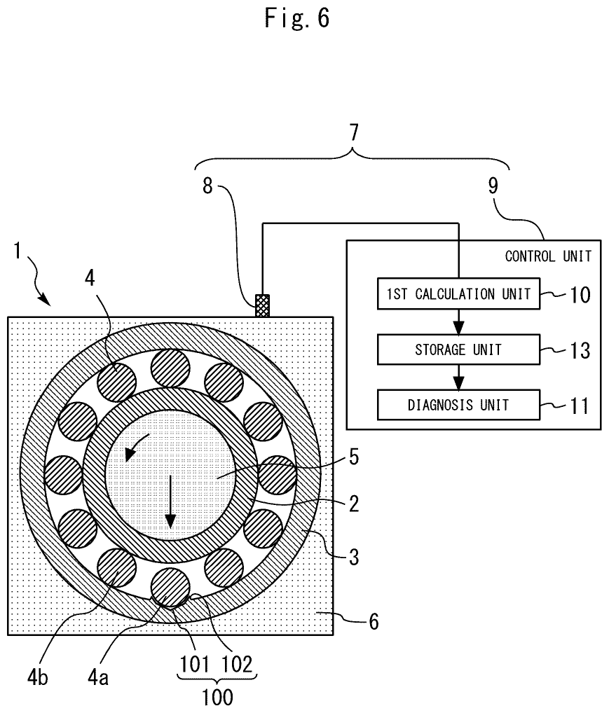

FIG. 6 is a configuration diagram of a rolling bearing according to a seventh embodiment.

The control unit 9 of the diagnostic device 7 of the rolling bearing 1 includes the first calculation unit 10, a storage unit 13 and the diagnosis unit 11.

The storage unit 13 is a portion having a function of storing information. The storage unit 13 accumulates and stores the calculated evaluation index. The storage unit 13 stores the evaluation indexes, for example, as time-series data. The storage unit 13, for example, stores the time-series data of the evaluation speed as the evaluation index. In a case where the diagnostic device 7 calculates the evaluation vibration as the evaluation index, the storage unit 13 may store time-series data of one or both of the evaluation speed and the evaluation vibration as the evaluation index. The storage unit 13 stores a temporal change of the evaluation index by storing the evaluation index as the time-series data. Further, the storage unit 13 may, for example, store a change amount such as a time differential value of the evaluation index calculated by the diagnosis unit 11, and the like.

Here, in rotation equipment in which a plurality of rolling bearings 1 with different specification conditions such as a size and a rotation speed is provided, even if sizes of damages occurring to the respective rolling bearings 1 are the same, the evaluation index such as the evaluation speed and the evaluation vibration may take different values depending on a difference in use condition. For example, the evaluation speed and the evaluation vibration for damage of the same degree tend to increase as the size and the rotation speed of the rolling bearing 1 are larger.

The diagnosis unit 11 diagnoses the damage to the rolling bearing 1 based on the information stored in the storage unit 13. The diagnosis unit 11, for example, calculates a first-order differential value of the evaluation index that is a temporal change rate of the evaluation index and diagnoses a damage condition from the first-order differential value of the evaluation index. By this means, the diagnosis unit 11 diagnoses the damage condition based on the change rate of the evaluation index, so that it is possible to diagnose the damage to the rolling bearings 1 with different specification conditions with higher accuracy.

Further, the diagnosis unit 11 may estimate a remaining lifespan until the evaluation index reaches a threshold that is a lifespan of the rolling bearing 1 based on the time-series data of the evaluation index, and the like, stored in the storage unit 13. This enables the diagnostic device 7 to determine an appropriate replacement time or maintenance check time of the rolling bearing 1. In this manner, the diagnostic device 7 can contribute to labor saving of maintenance and long-term stable operation of the rolling bearing 1, peripheral equipment of the rolling bearing 1, and the whole rotation equipment in which the rolling bearing 1 is provided.

### Eighth Embodiment

The rolling bearing 1 includes the inner ring 2, the outer ring 3, the plurality of rolling elements 4, the rotation shaft 5, and the diagnostic device 7.

Typically, the rolling bearing is a portion to which the largest load is applied in the rotation equipment and that is likely to break down first. If damage occurs to the rolling bearing, there is a case where the damage may become large at an accelerated rate as a result of stress around the damage becoming large. If the damage becomes large, behavior of the whole rotation equipment including the rotation shaft becomes unstable, which can lead to damage to peripheral equipment and the rotation shaft of the rolling bearing, a gear and a coupling, a stator, a housing, a frame, or the like.

Concerning this, the rolling bearing 1 can diagnose damage to the rolling bearing 1 and rotation equipment in which the rolling bearing 1 is provided with high accuracy by the attached diagnostic device 7. This makes it possible to prevent in advance a failure of peripheral equipment of the rolling bearing 1 and the whole rotation equipment in which the rolling bearing 1 is provided as well as the rolling bearing 1 itself.

In the rolling bearing 1 according to any of the first to the eighth embodiments, the rolling bearing 1 may employ, for example, a configuration in which both the inner ring 2 and the outer ring 3 rotate in an integrated manner with different rotation shafts 5.

### Ninth Embodiment

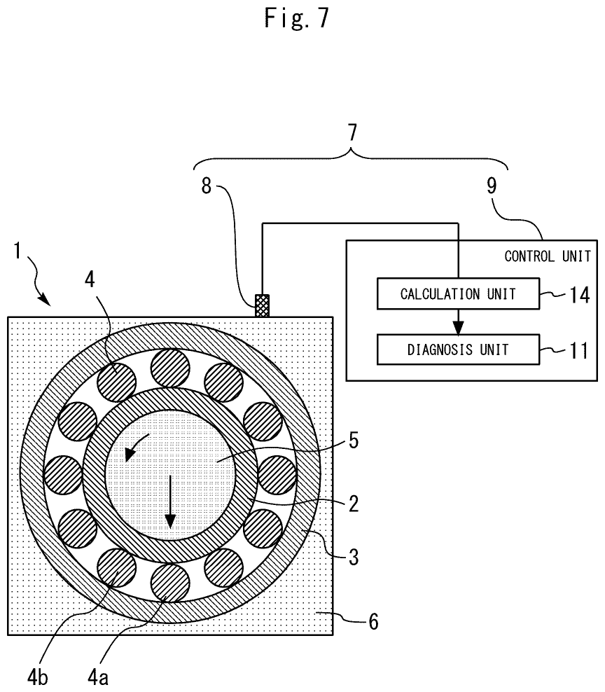

FIG. 7 is a configuration diagram of the rolling bearing 1 according to a ninth embodiment.

The rolling bearing 1 includes the inner ring 2, the outer ring 3, the plurality of rolling elements 4, and the rotation shaft 5. FIG. 1 illustrates a section of the rolling bearing 1 along a plane perpendicular to a shaft core of the rotation shaft 5. The inner ring 2 has a cylindrical shape, and the outer ring 3 has a cylindrical shape. The outer ring 3 is arranged concentrically with the inner ring 2 outside the inner ring 2. The plurality of rolling elements 4 is arranged between the inner ring 2 and the outer ring 3. Each of the rolling elements 4 has a rollable shape such as a spherical shape or a columnar shape. The rolling elements 4 are arranged between a raceway surface that is an inner peripheral surface of the outer ring 3 and a raceway surface that is an outer peripheral surface of the inner ring 2. The rolling elements 4 roll in association with rotation of the inner ring 2 or rotation of the outer ring 3. Here, in a case where individual rolling elements 4 are distinguished from each other, one of the plurality of rolling elements 4 may be described as a rolling element 4a, a rolling element 4b, or the like.

The rotation shaft 5 rotates in an integrated manner with the inner ring 2 or the outer ring 3. The rotation shaft 5 in this example rotates counterclockwise on paper in FIG. 1. Here, a shaft direction along the shaft core of the rotation shaft 5, that is, an extending direction of the rotation shaft 5 may be simply referred to as a shaft direction. Further, a circumferential direction around the shaft core of the rotation shaft 5, that is, a rotation direction of the rotation shaft 5 may be simply referred to as a circumferential direction. Still further, a direction toward an outside of the rotation shaft 5 from the shaft core of the rotation shaft 5 may be simply referred to as a radial direction.

In the rolling bearing 1 in this example, the inner ring 2 rotates in an integrated manner with the rotation shaft 5, and the outer ring 3 is held and fixed in the housing 6. Note that in the rolling bearing 1, the inner ring 2 may be held and fixed in the housing 6, and the outer ring 3 may rotate in an integrated manner with the rotation shaft 5 provided outside the outer ring 3.

The rolling bearing 1 is held in the housing 6. The housing 6 holds the inner ring 2 or the outer ring 3 of the rolling bearing 1.

In the rolling bearing 1, the diagnostic device 7 is applied. The diagnostic device 7 has a function of diagnosing a condition of damage, and the like, to the rolling bearing 1. The diagnostic device 7 may be a device included as part of rotation equipment such as a motor, in which the rolling bearing 1 is provided or may be an external device to be externally applied to the rotation equipment. The diagnostic device 7 may be a device provided all the time in the rolling bearing 1 or the rotation equipment in which the rolling bearing 1 is provided or may be a device temporarily provided as a portable device in the rolling bearing 1 or the rotation equipment in which the rolling bearing 1 is provided. The diagnostic device 7 includes the behavior sensor 8 and the control unit 9.

The behavior sensor 8 is attached to the inner ring 2, the outer ring 3, or the housing 6 that holds the inner ring 2 or the outer ring 3. The behavior sensor 8 is a sensor that measures behavior of the rolling bearing 1, such as behavior of the inner ring 2, the outer ring 3 or the housing 6. The behavior sensor 8 is, for example, an acceleration sensor, a displacement sensor, or a speed sensor.

The control unit 9 has a function of performing data processing in the diagnostic device 7. The control unit 9 may include one or more pieces of independent hardware or may be part of other hardware such as control equipment of the rotation equipment in which the rolling bearing 1 is provided. The control unit 9 includes a calculation unit 14 and the diagnosis unit 11.

The calculation unit 14 is a portion having a function of calculating an evaluation speed to be used for diagnosis of the rolling bearing 1. The evaluation speed is calculated for a period equal to or longer than the cycle Tr of the characteristic vibration determined by the specifications of the rolling bearing 1. The evaluation speed is a maximum speed component in a direction in which a load from the rotation shaft 5 acts within the period. The direction in which the load from the rotation shaft 5 acts is, for example, an outward direction in the radial direction or a downward direction in the vertical direction. In this event, a direction opposite to the direction in which the load from the rotation shaft 5 acts is an inward direction in the radial direction or an upward direction in the vertical direction. Here, the direction in which the load from the rotation shaft 5 acts and the direction opposite to the direction in which the load from the rotation shaft 5 acts may be respectively expressed as a load direction and an anti-load direction. The calculation unit 14 may have some or all of the functions of the first calculation unit 10, the second calculation unit 12, and the like, in the diagnostic device 7 according to other embodiments.

The calculation unit 14 calculates the evaluation speed by processing the output signal from the behavior sensor 8. For example, in a case where the behavior sensor 8 is a speed sensor, the calculation unit 14 calculates the evaluation speed using time-series data of a speed that is the output signal from the behavior sensor 8. Further, in a case where the behavior sensor 8 is an acceleration sensor, the calculation unit 14 performs time integration on time-series data of an acceleration that is the output signal from the behavior sensor 8 to calculate time-series data of the speed. In this event, the calculation unit 14 calculates the evaluation speed using the calculated time-series data of the speed. Further, in a case where the behavior sensor 8 is a displacement sensor, the calculation unit 14 differentiates with respect to time, time-series data of a displacement that is the output signal from the behavior sensor 8 to calculate time-series data of the speed. In this event, the calculation unit 14 calculates the evaluation speed using the calculated time-series data of the speed.

The calculation unit 14 calculates as the evaluation speed, a maximum speed component in the direction in which the load from the rotation shaft 5 acts from the time-series data of the speed for a period equal to or longer than the cycle Tr set in advance.

The diagnosis unit 11 is a portion having a function of diagnosing damage to the rolling bearing 1 by using an evaluation index based on the evaluation speed calculated by the calculation unit 14. In this example, the diagnosis unit 11 diagnoses the damage to the rolling bearing 1 using the evaluation index based on the evaluation speed calculated by the calculation unit 14 and relative rotation speed of the inner ring 2 and the outer ring 3.

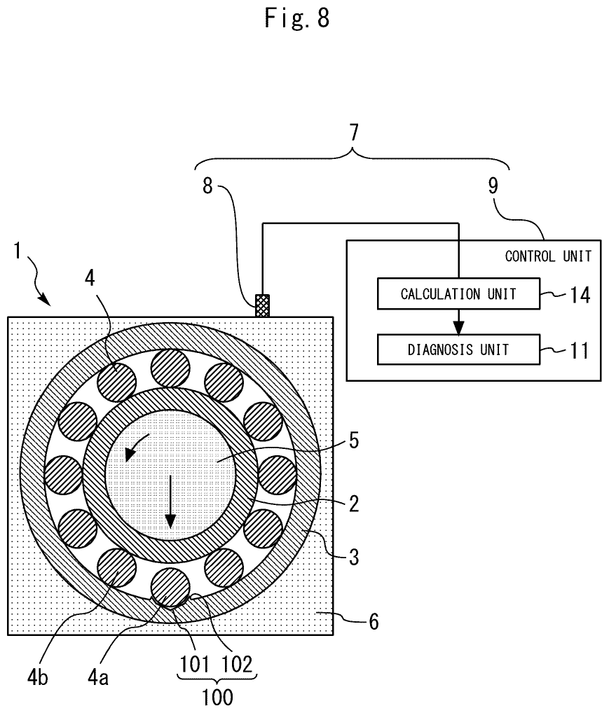

Subsequently, an example of diagnosis of the damage to the rolling bearing 1 by the diagnostic device 7 will be described using FIG. 8. FIG. 8 is a diagram for explaining an example of diagnosis of the damage to the rolling bearing 1 by the diagnostic device according to the ninth embodiment. FIG. 8 illustrates the damaged portion 100 as an example of the damage that can occur to the rolling bearing 1. The damaged portion 100 occurs in the rolling bearing 1, for example, as follows.

In the rolling bearing 1 in this example, the rotation shaft 5 rotates counterclockwise on paper in an integrated manner with the inner ring 2. In this event, each rolling element 4 in contact with the raceway surface of the inner ring 2 rotationally moves so as to revolve around a central axis of the rotation shaft 5 between the inner ring 2 and the outer ring 3 counterclockwise on paper while rotating around a central point of the rolling element 4 itself clockwise on paper in association with rotation of the inner ring 2. In other words, the plurality of rolling elements 4 located between the inner ring 2 and the outer ring 3 rotationally moves in the circumferential direction so as to revolve between the inner ring 2 and the outer ring 3 while rolling in association with rotation of the inner ring 2. While an example where the inner ring 2 rotates is described, in a case where the outer ring 3 also rotates, the plurality of rolling elements 4 located between the inner ring 2 and the outer ring 3 rotationally moves in the circumferential direction so as to revolve between the inner ring 2 and the outer ring 3 while rolling in association with rotation of the outer ring 3, or rotation of both the inner ring 2 and the outer ring 3. A rolling speed of the rolling element 4 around the central point of the rolling element 4 itself is proportional to the relative rotation speed of the inner ring 2 and the outer ring 3. A rotational movement speed of the rolling element 4 in the circumferential direction around the central axis of the rotation shaft 5 is proportional to the relative rotation speed of the inner ring 2 and the outer ring 3, and a diameter of a trajectory of the center of the rolling element 4 when the rolling element 4 rotationally moves in the circumferential direction so as to revolve around the central axis of the rotation shaft 5.

In a case where load on the inner ring 2 by the load of the rotation shaft 5, and the like, acts in the downward direction on paper, most of the load from the rotation shaft 5 is transmitted to the raceway surface of the inner ring 2 and the raceway surface of the outer ring 3 via the plurality of rolling elements 4, and the like, located below the rotation shaft 5. When the rotation shaft 5 stands still, a position and a magnitude of the load occurring in each of the inner ring 2, the outer ring 3 and the rolling element 4 do not largely change. On the other hand, when the rotation shaft 5 rotates, the position and the magnitude of the load periodically change in association with rotational movement of the inner ring 2 and the rolling element 4. By this means, repetitive stress loads act on the raceway surfaces of the inner ring 2 and the outer ring 3, and the rolling element 4. Due to such repetitive stress loads, a crack, for example, which originates from impurities inside a material, may make progress from an inside of the inner ring 2, the outer ring 3, the rolling element 4, or the like, and reach a surface. In this event, an internally-originating flaking-off damage that is scalelike flaking off of a surface zone can occur on the raceway surface, or the like, of the inner ring 2, the outer ring 3, or the rolling element 4.

Further, abnormal slipping can occur between the rolling element 4, and the inner ring 2 and the outer ring 3 due to poor lubrication of the raceway surface caused by insufficient greasing of a lubricant such as grease, deterioration, leak, insufficient viscosity, excessive load, or the like. In this event, stress is likely to concentrate on a surface of the raceway surface due to rough surface, wear, or the like, of the raceway surface, and damage to the raceway surface may be further accelerated. As an example, a surface-originating flaking-off damage which is scalelike flaking off of a surface zone of part of the raceway surface, wear damage, seizure damage or the like, may occur on the raceway surface.

Concerning the internally-originating flaking-off damage, there is a lifespan design formula called L10 life, and specifications of the rolling bearing 1 are normally determined based on the lifespan design formula, and thus, the internally-originating flaking-off damage hardly occurs. On the other hand, the surface-originating flaking-off damage can occur extremely earlier than the internally-originating flaking-off damage, and thus, it is important to diagnose a condition of the rotation equipment to secure reliability and achieve long-term operation of the rolling bearing 1 and the rotation equipment in which the rolling bearing 1 is provided.

According to the knowledge obtained from a bearing test, the damaged portion 100 by the flaking-off damage is often formed on the raceway surface of the rolling bearing 1. Further, the damaged portion 100 is often constituted of the recessed portion 101 and the damaged corner portion 102. It is considered that sizes and shapes of the recessed portion 101 and the damaged corner portion 102 are always changing in accordance with a total number of rotations of the rolling bearing 1, which is a cumulative number of relative rotations of the inner ring 2 and the outer ring 3 of the rolling bearing 1. Further, the recessed portion 101 becomes larger as the total number of rotations of the rolling bearing 1 increases. On the other hand, it has been confirmed that the shape of the damaged corner portion 102 is sharp in an initial stage of occurrence of the damage, but thereafter, may change to a smooth shape by wear, and the like. In a case where the damaged portion 100 is caused by the surface-originating flaking-off damage, a depth of the recessed portion 101 is shallow in an initial stage of occurrence of the damage, and thus, the recessed portion 101 becomes larger in a shaft direction and in the circumferential direction and also becomes deeper in a radial direction during progress of the damage.

While as a result of a shape of the damaged corner portion 102 becoming sharp, instantaneous vibration increases or an impact increases, this does not lead to large rattling of the whole rotation equipment, and thus, lifespans of rolling bearing 1 and rotation equipment in which the rolling bearing 1 is provided are less affected by the damaged corner portion 102. Further, the shape of the damaged corner portion 102 sensitively is changed by the wear, and the like, and thus, is unsuitable for use in diagnosis. On the other hand, the recessed portion 101 becomes larger as the total number of rotations of the rolling bearing 1 increases, which can lead to continuous increase, and the like, of rattling, wobble or abnormal noise of the rolling bearing 1 and peripheral equipment of the rolling bearing 1, and the whole rotation equipment in which the rolling bearing 1 is provided. Thus, the size of the recessed portion 101 largely affects the lifespans of the rolling bearing 1 and the whole rotation equipment in which the rolling bearing 1 is provided, and thus, diagnosis of the size of the recessed portion 101 leads to diagnosis of the lifespan of the whole rotation equipment.

For example, as illustrated in FIG. 1, consideration will be given to a case where in the inner-ring-rotation-type rolling bearing 1 in which the inner ring 2 rotates along with the rotation shaft 5, the recessed portion 101 is formed on a load side of the outer ring 3. If the recessed portion 101 becomes larger, the rolling element 4 sinks down in the recessed portion 101 at a timing at which the rolling element 4 arrives at the recessed portion 101 upon rotation of the rolling bearing 1. In this event, the rolling element 4 drops in a depth direction of the recessed portion 101 along with the inner ring 2 and the rotation shaft 5. Further, the rolling element 4 rises from a bottom portion of the recessed portion 101 along with the inner ring 2 and the rotation shaft 5 at a timing at which the rolling element 4 goes out from the recessed portion 101. Thus, rattling, wobble and abnormal noise of the rolling bearing 1 and the rotation shaft 5 become larger as the recessed portion 101 is deeper. If the recessed portion 101 becomes too deep, rattling, wobble and abnormal noise of the rolling bearing 1 and the rotation shaft 5 may become extremely large. In this event, there is a case where a design upper limit of the rotation equipment in which the rolling bearing 1 is provided may be exceeded. Further, there is a case where this may lead to a failure such as a crack in or breakage of the rolling bearing 1, a failure of peripheral equipment of the rolling bearing 1, a failure of the whole rotation equipment in which the rolling bearing 1 is provided, and the like.

It is therefore important to diagnose a condition of a size or a degree of the damage to the rolling bearing 1, such as a depth of the recessed portion 101 in order to diagnose a condition, a damage condition, a lifespan, and the like, of the rotation equipment. By diagnosing the condition of the rolling bearing 1, it is possible to detect an abnormality in and estimate a remaining lifespan of the rolling bearing 1, and the like, and perform maintenance and lifespan extension treatment by replacement of the rolling bearing 1 or grease at an appropriate timing. Further, this makes it possible to save labor of the maintenance and achieve long-term stable operation of the rolling bearing 1, the peripheral equipment of the rolling bearing 1, and the whole rotation equipment in which the rolling bearing 1 is provided.

The diagnostic device 7 diagnoses the damaged portion 100 as illustrated in FIG. 8, for example, as follows. Note that while a case where the damaged portion 100 has occurred in the outer ring 3 is illustrated as an example in FIG. 8, the damaged portion 100 may occur in the inner ring 2 or the rolling element 4.

The calculation unit 14 calculates the evaluation speed for a period equal to or longer than the cycle Tr of the characteristic vibration determined by the specifications of the rolling bearing 1. The characteristic vibration described here includes not only vibration occurring when the rolling element 4 passes through the damaged portion 100 that has occurred in the outer ring 3 as illustrated in FIG. 2, but also vibration occurring when the rolling element 4 passes through the damaged portion 100 that has occurred in the inner ring 2, and vibration occurring when the inner ring 2 and the outer ring 3 pass through the damaged portion 100 that has occurred in the rolling element 4. Here, among the cycle Tr, a cycle of characteristic vibration originating from damage to the inner ring 2 is defined as Trᵢ [sec], a cycle of characteristic vibration originating from damage to the outer ring 3 is defined as Trₒ [sec], and a cycle of characteristic vibration originating from damage to the rolling element 4 is defined as Tr_{b} [sec]. In a case where damage has occurred to the inner ring 2, the characteristic vibration of the cycle Trᵢ is particularly large, in a case where damage has occurred to the outer ring 3, the characteristic vibration of the cycle Trₒ is particularly large, and in a case where damage has occurred to the rolling element 4, the characteristic vibration of the cycle Tr_{b} is particularly large. For example, in a case where the outer ring 3 has the damaged portion 100 as illustrated in FIG. 8, a period from when the rolling element 4a passes through the damaged portion 100 until when the rolling element 4b passes through the damaged portion 100 becomes the cycle Trₒ. For example, in a case where a diameter of the rolling element 4 is defined as d [mm], a diameter of a trajectory of a center of the rolling element 4 is defined as D [mm], the number of rolling elements 4 is defined as Z, a contact angle of the rolling element 4 is defined as a [rad], and the relative rotation speed of the inner ring 2 and the outer ring 3 is defined as fₛ [rps], the cycle Trᵢ of the characteristic vibration originating from the damage to the inner ring 2, the cycle Trₒ of the characteristic vibration originating from the damage to the outer ring 3, and the cycle Tr_{b} of the characteristic vibration originating from the damage to the rolling element 4 are respectively expressed with the following expression (4), expression (5) and expression (6). Here, the contact angle α of the rolling element 4 is an angle formed by a line connecting a contact point of the inner ring 2 and the rolling element 4 and a contact point of the rolling element 4 and the outer ring 3 on a section along the shaft direction of the rotation shaft 5, and a line vertical to the central axis of the rotation shaft 5 on the same section.

$$\begin{matrix}[ Math . 4 ] & \\ T {r}_{i} = \frac{2}{{f}_{s} Z} ( \frac{1}{1 + \frac{d}{D} cos α} ) & ( 4 )\end{matrix}$$

$$\begin{matrix}[ Math . 5 ] & \\ {Tr}_{o} = \frac{2}{{f}_{s} Z} ( \frac{1}{1 - \frac{d}{D} cos α} ) & ( 5 )\end{matrix}$$

$$\begin{matrix}[ Math . 6 ] & \\ T {r}_{b} = \frac{2}{{f}_{s}} ( \frac{D d}{( {D}^{2} - {d}^{2} ) {cos}^{2} α} ) & ( 6 )\end{matrix}$$

In this manner, the cycle Tr of the characteristic vibration determined by the specifications of the rolling bearing 1 and the relative rotation speed of the inner ring 2 and the outer ring 3 can be obtained as Trᵢ of expression (4) in a case where damage has occurred to the inner ring 2, can be obtained as Trₒ of expression (5) in a case where damage has occurred to the outer ring (3), and can be obtained as Tr_{b} of expression (6) in a case where damage has occurred to the rolling element 4. In any position where the damage has occurred, the cycle Tr of the characteristic vibration can be determined by using the relative rotation speed fₛ of the inner ring 2 and the outer ring 3, the diameter d of the rolling element 4, the diameter D of the trajectory of the center of the rolling element 4, and the contact angle α of the rolling element 4.

Concerning the cycle Trᵢ of the characteristic vibration in a case where damage has occurred to the inner ring 2, for example, the following can be understood from a relationship between a numerator and a denominator of each expression. The cycle Trᵢ becomes shorter in inverse proportion as the relative rotation speed fₛ becomes larger. The cycle Trᵢ becomes shorter in inverse proportion as the number Z of the rolling elements 4 becomes larger. The cycle Trᵢ becomes longer as the diameter D of the trajectory of the center of the rolling element 4 becomes larger. The cycle Trᵢ becomes shorter as the diameter d of the rolling element 4 becomes larger. The cycle Trᵢ becomes longer as the contact angle α becomes larger. Further, for example, concerning the cycle Trₒ of the characteristic vibration in a case where damage has occurred to the outer ring 3, the following can be understood. The cycle Trₒ becomes shorter in inverse proportion as the relative rotation speed fₛ becomes larger. The cycle Trₒ becomes shorter in inverse proportion as the number Z of the rolling elements 4 becomes larger. The cycle Trₒ becomes shorter as the diameter D of the trajectory of the center of the rolling element 4 becomes larger. The cycle Trₒ becomes longer as the diameter d of the rolling element becomes larger. The cycle Trₒ becomes shorter as the contact angle α becomes larger. Further, for example, concerning the cycle Tr_{b} of the characteristic vibration in a case where damage has occurred to the rolling element 4, the following can be understood. The cycle Tr_{b} becomes shorter in inverse proportion as the relative rotation speed fₛ becomes larger. The cycle Tr_{b} becomes shorter as the contact angle α becomes larger. Further, while the diameter D of the trajectory of the center of the rolling element 4 and the diameter d of the rolling element are included in both the numerator and the denominator of expression (6), considering that influence of a squared term of the denominator is larger than influence of a cross term of the numerator, the cycle Tr_{b} often becomes shorter as the diameter D of the trajectory of the center of the rolling element 4 becomes larger, and becomes longer as the diameter d of the rolling element 4 becomes larger.

Note that there are various ways of providing the relative rotation speed fₛ in accordance with a rotation pattern of the rolling bearing 1, and, for example, as illustrated in FIG. 7, in a case where the outer ring 3 is fixed, and the inner ring 2 rotates in an integrated manner with the rotation shaft 5, the relative rotation speed fₛ can be provided as the rotation speed of the inner ring 2 or the rotation speed of the rotation shaft 5. Further, in a case where the inner ring 2 is fixed, and the outer ring 3 rotates in an integrated manner with the rotation shaft, the relative rotation speed fₛ can be provided as the rotation speed of the outer ring 3 or the rotation speed of the rotation shaft. Still further, in a case where the inner ring 2 and the outer ring 3 rotate in the same direction in an integrated manner with different rotation shafts, the relative rotation speed fₛ can be provided as an absolute value of a difference value between the rotation speed of the inner ring 2 and the rotation speed of the outer ring 3. Further, in a case where the inner ring 2 and the outer ring 3 rotate in reverse directions in an integrated manner with different rotation shafts, the relative rotation speed fₛ can be provided as a total value of the rotation speed of the inner ring 2 and the rotation speed of the outer ring 3.

Subsequently, an example of diagnosis based on a motion equation when the rolling element 4 sinks down in the recessed portion 101 will be described.

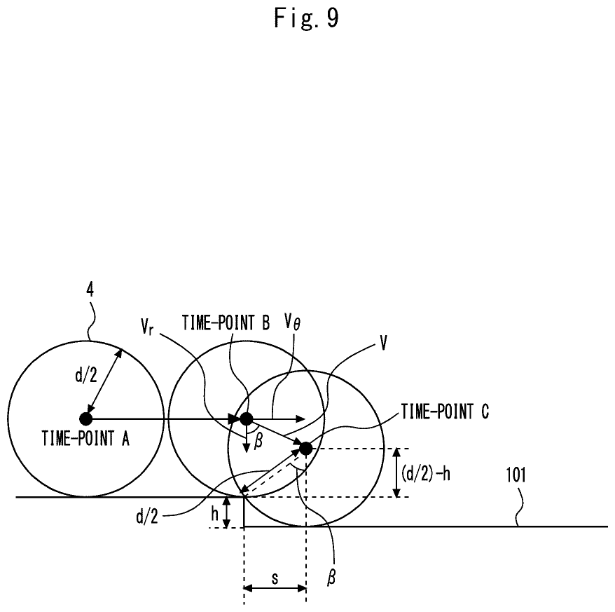

The motion equation when the rolling element 4 sinks down in the recessed portion 101 is solved, and a depth h [mm] of the recessed portion 101 is calculated using FIG. 9. FIG. 9 is a diagram for explaining an example of behavior when the rolling element 4 of the rolling bearing 1 passes through the damaged portion 100.

Here, the diameter of the rolling element 4 is defined as d, the diameter of the trajectory of the center of the rolling element 4 when the rolling element 4 rotationally moves so as to revolve around the central axis of the rotation shaft 5 between the inner ring 2 and the outer ring 3 counterclockwise on paper is defined as D [mm], and the rotation speed in a revolution direction of the rolling element 4 is defined as fₒ [rps]. Further, a period from when the rolling element 4 starts to sink down in the recessed portion 101 until when the rolling element 4 collides with a surface of the recessed portion 101 is defined as t [sec], an average speed of the rolling element 4 within the period t is defined as V [mm/sec], an average speed in the radial direction of the rolling element 4 within the period t is defined as Vᵣ [mm/sec], an average speed in the circumferential direction of the rolling element 4 within the period t is defined as Ve [mm/sec], a moving distance in the circumferential direction of the rolling element 4 within the period t is defined as s [mm], and an angle formed by a line of the trajectory of the center of the rolling element 4 and a line in the radial direction connecting the center of the rotation shaft 5 and the center of the rolling element 4 within the period t is defined as β [rad].

The depth h [mm] of the recessed portion 101 can be expressed with the following expression (7) from a formula of a trigonometric function, and the speed Ve in the circumferential direction of the rolling element 4 can be expressed with the following expression (8).

$$\begin{matrix}[ Math . 7 ] & \\ h = ( \frac{d}{2} ) ( 1 - cos β ) & ( 7 )\end{matrix}$$

$$\begin{matrix}[ Math . 8 ] & \\ {V}_{θ} = D π {f}_{o} & ( 8 )\end{matrix}$$

In a case where the load in the radial direction acting on the rolling element 4 is sufficiently large, the period t from when the rolling element 4 starts to sink down in the recessed portion 101 until when the rolling element 4 collides with the surface of the recessed portion 101 is equal to a period required for the rolling element 4 to make progress by the depth h of the recessed portion 101 at the radial-direction speed Vᵣ and a period required for the rolling element 4 to make progress by the circumferential-direction distance s at the circumferential-direction speed Ve. Thus, the radial-direction speed Vᵣ of the rolling element 4 can be expressed with the following expression (9) using expression (7) and expression (8).

$$\begin{matrix}[ Math . 9 ] & \\ {V}_{r} = \frac{h}{t} = \frac{h}{\frac{s}{{V}_{θ}}} = \frac{h}{\frac{( \frac{d}{2} ) sin β}{{V}_{θ}}} = \frac{( \frac{d}{2} ) ( 1 - cos β ) D π {f}_{o}}{( \frac{d}{2} ) sin β} & ( 9 )\end{matrix}$$

The following expression (10) can be obtained by further organizing expression (9).

$$\begin{matrix}[ Math . 10 ] & \\ ( 1 - cos β ) = \frac{{V}_{r} sin β}{D π {f}_{o}} & ( 10 )\end{matrix}$$

Here, in a case where a restitution coefficient when the rolling element 4 sinks down in and collides with the recessed portion 101 is defined as e, a radial-direction speed of a structure that moves in coordination with the recessed portion 101 before the collision is defined as Voᵣ [mm/sec], a radial-direction speed of the structure that moves in coordination with the recessed portion 101 immediately after the collision is defined as Voᵣ′ [mm/sec], and a radial-direction speed of the rolling element 4 after the collision is defined as Vᵣ′ [mm/sec], a relational expression of the respective speeds upon restitution can be expressed as the following expression (11).

$$\begin{matrix}[ Math . 11 ] & \\ e ( {V}_{r} - {Vo}_{r} ) = {Vo}_{r}^{′} - {V}_{r}^{′} & ( 11 )\end{matrix}$$

Further, here, in a case where a mass of all the structures including the rolling element 4, the inner ring 2, and the rotation shaft 5 that apply a load to the recessed portion 101 via the rolling element 4 is defined as m [kg], and a mass of the structure that moves in coordination with the recessed portion 101 is defined as mₒ [kg], a relational expression of the respective speeds can be also expressed with following expression (12) by the law of conservation of momentum.

$$\begin{matrix}[ Math . 12 ] & \\ m {V}_{r} + {m}_{o} {Vo}_{r} = m {V}_{r}^{′} + {m}_{o} {Vo}_{r}^{′} & ( 12 )\end{matrix}$$

Here, if, assuming that the radial-direction speed Voᵣ of the recessed portion 101 before the collision is 0, a relational expression that expresses Vᵣ with Voᵣ′ is obtained using expression (11) and expression (12) and is substituted into Vᵣ of expression (10), the following expression (13) is obtained.

$$\begin{matrix}[ Math . 13 ] & \\ ( 1 - cos β ) = \frac{( m + {m}_{o} ) V {o}_{r}^{′} sin β}{( 1 + e ) m D π {f}_{o}} ( ∵ {Vo}_{r} = 0 ) & ( 13 )\end{matrix}$$

Here, if expression (13) is substituted into expression (7), the depth h of the recessed portion 101 can be expressed with the following expression (14).

$$\begin{matrix}[ Math . 14 ] & \\ h = ( \frac{d}{2} ) ( 1 - cos β ) = sin β \frac{( 1 + \frac{{m}_{o}}{m} )}{2 π ( 1 + e ) \frac{D}{d}} \cdot \frac{V {o}_{r}^{′}}{{f}_{o}} & ( 14 )\end{matrix}$$

Here, if the relative rotation speed of the inner ring 2 and the outer ring 3 is defined as fₛ [rps], and the contact angle of the rolling element 4 is defined as a [rad], the rotation speed fₒ [rps] in the revolution direction of the rolling element 4 can be expressed with the following expression (15).

$$\begin{matrix}[ Math . 15 ] & \\ {f}_{o} = \frac{{f}_{s}}{2} ( \frac{D - d cos α}{D} ) & ( 15 )\end{matrix}$$

The rotation speed fₒ in the revolution direction of the rolling element 4 in a case where there is less slipping is also substantially the same as a result obtained through expression (15). Here, if expression (15) is substituted into expression (14), and a constant determined by each mass and the shape and the dimension of the rolling bearing 1 is replaced as a coefficient A, the depth h of the recessed portion 101 can be expressed with the following expression (16).

$$\begin{matrix}[ Math . 16 ] & \\ h = A sin β \frac{V {o}_{r}^{′}}{{f}_{s}} , A = \frac{( 1 + \frac{{m}_{o}}{m} )}{π ( 1 + e ) ( \frac{D}{d} - cos α )} & ( 16 )\end{matrix}$$

Here, the rolling element 4 moves in the circumferential direction by the distance s while the rolling element 4 moves in the radial direction by the distance h, and thus, the moving distance s in the circumferential direction can be expressed with the following expression (17) from the Pythagorean theorem.

$$\begin{matrix}[ Math . 17 ] & \\ s = \sqrt{{( \frac{d}{2} )}^{2} - {( ( \frac{d}{2} ) - h )}^{2}} = \sqrt{d h - {h}^{2}} & ( 17 )\end{matrix}$$

Further, sinβ used in expression (16) can be expressed with the following expression (18) from a formula of a trigonometric function using the moving distance s in the circumferential direction.

$$\begin{matrix}[ Math . 18 ] & \\ sin β = \frac{s}{( \frac{d}{2} )} = \frac{2 \sqrt{d h - {h}^{2}}}{d} & ( 18 )\end{matrix}$$

If expression (16) is substituted into expression (18) and organized, the depth h of the recessed portion 101 can be expressed with the following expression (19).

$$\begin{matrix}[ Math . 19 ] & \\ h = \frac{d}{1 + {( \frac{d}{2 A} )}^{2} \frac{1}{{( \frac{{Vo}_{r}^{′}}{{f}_{s}} )}^{2}}} , A = \frac{( 1 + \frac{{m}_{o}}{m} )}{π ( 1 + e ) ( \frac{D}{d} - cos α )} & ( 19 )\end{matrix}$$

The radial-direction speed Voᵣ′ of the outer ring 3 or the housing 6 that holds the outer ring 3 which is one of the structures that move in coordination with the recessed portion 101 becomes maximum immediately after the rolling element 4 collides with the recessed portion 101. Thus, the radial-direction speed Voᵣ′ corresponds to the evaluation speed that is the maximum speed component in a direction of the load acting on the rolling bearing 1 from the rotation shaft 5 that rotates in an integrated manner with the inner ring 2 or the outer ring 3. From expression (19), by using the diameter d of the rolling element 4, the diameter D of the trajectory of the center of the rolling element 4, the mass m of all the structures which apply the load to the recessed portion 101 via the rolling element 4 and which include the rolling element 4, the inner ring 2 and the rotation shaft 5, the load acting on the rolling bearing 1 from the rotation shaft 5 corresponding to this, and the mass mₒ of the structure that moves in coordination with the recessed portion 101, and the like, and a relative evaluation speed (Voᵣ′/fₛ) obtained by dividing the evaluation speed Voᵣ′ by the relative rotation speed fₛ, the depth h of the recessed portion 101 can be calculated.

Further, from expression (19), it can be diagnosed that the depth h of the recessed portion 101 is larger as the relative evaluation speed (Voᵣ′/fₛ) is higher. Further, from a relationship, and the like, of the numerator and the denominator of expression (19), in a case where the relative evaluation speed (Voᵣ′/fₛ) is the same, it can be diagnosed that the depth h of the recessed portion 101 is larger as the value obtained by dividing the mass mₒ of the structure that moves in coordination with the recessed portion 101 by the mass m is larger. Here, the mass m is a mass of all the structures which apply the load to the recessed portion 101 via the rolling element 4 and which include the rolling element 4, the inner ring 2, and the rotation shaft 5. Further, from the relationship, and the like, of the numerator and the denominator of expression (19), in a case where the relative evaluation speed (Voᵣ′/fₛ) is the same, it can be diagnosed that the depth h of the recessed portion 101 is larger as the diameter D of the trajectory of the center of the rolling element 4 is smaller. Further, from the relationship, and the like, of the numerator and the denominator of expression (19), in a case where the relative evaluation speed (Voᵣ′/fₛ) is the same, it can be diagnosed that the depth h of the recessed portion 101 is larger as the restitution coefficient e when the rolling element 4 sinks down in and collides with the recessed portion 101 is smaller.

Note that the restitution coefficient e is related to hardness of a material, and if objects formed with materials with high hardness are made to collide with each other, the restitution coefficient e often becomes large. Thus, from the relationship, and the like, of the numerator and the denominator of expression (19), in a case where the relative evaluation speed (Voᵣ′/fₛ) is the same, it can be diagnosed that the depth h of the recessed portion 101 is larger as hardness of the rolling element 4 and the outer ring 3 having the recessed portion 101 is lower. Further, a logarithmic value of hardness of the material and the restitution coefficient often have a proportional relation, and thus, it is possible to obtain the restitution coefficient based on the logarithmic value of the hardness of the material, and diagnose the depth h of the recessed portion 101 by expression (19). Further, bearing steel is often used as a material of the rolling element 4 and the outer ring 3 having the recessed portion 101, and thus, the depth h of the recessed portion 101 can be diagnosed based on the restitution coefficient e between the bearing steel, hardness of the bearing steel, and the like. On the other hand, there is also a case where a material such as ceramic is used for the rolling element 4, and the like, in the rolling bearing 1. It is therefore necessary to take into account influence to be provided to vibration by a difference in the material upon diagnosis of damage using vibration information. According to the configuration of the ninth embodiment, even if the material of the rolling bearing 1 changes, damage can be diagnosed with high accuracy based on the restitution coefficient e or hardness of the changed material.

Here, the structure that moves in coordination with the recessed portion 101 is, for example, the outer ring 3, the housing 6 that holds the outer ring 3, or the like. A speed of the outer ring 3 and the housing 6 is low before the rolling element 4 collides with the recessed portion 101, the speed Voᵣ′ in the load direction becomes a maximum value immediately after the collision, and thereafter gradually attenuates and becomes lower. According to the configuration of the ninth embodiment, the behavior sensor 8 provided on the outer ring 3 or the housing 6 that holds the outer ring 3, and the calculation unit 14 calculate the speed Voᵣ′ in the load direction immediately after the rolling element 4 collides with the recessed portion 101 as the evaluation speed. Thus, for example, the diagnosis unit 11 of the control unit 9 can diagnose the depth h of the recessed portion 101 of the rolling bearing 1 with high accuracy using the evaluation index based on the evaluation speed and the relative rotation speed fₛ.

Further, even if the damaged portion 100 has occurred in any position of the inner ring 2, the outer ring 3 and the rolling element 4, behavior of the rolling element 4 sinking down in the recessed portion 101 of the damaged portion 100 occurs at least once within the period equal to or longer than the cycle Tr of the characteristic vibration. The cycle Tr of the characteristic vibration can be calculated in advance from expression (4) to expression (6). Thus, among the cycle Trᵢ of the characteristic vibration when damage has occurred to the inner ring 2, the cycle Trₒ of the characteristic vibration when damage has occurred to the outer ring 3, and the cycle Tr_{b} of the characteristic vibration when damage has occurred to the rolling element 4, the longest cycle can be judged and employed. The control unit 9 acquires the evaluation speed that is the maximum speed component in the direction of the load acting on the rolling bearing 1 from the rotation shaft 5 that rotates in an integrated manner with the inner ring 2 or the outer ring 3 within the period equal to or longer than the employed longest cycle by the behavior sensor 8 attached to the inner ring 2, the outer ring 3 or the housing 6. The diagnosis unit 11 of the control unit 9 can diagnose the damage with high accuracy by diagnosing the damage to the rolling bearing 1 using the evaluation index based on the evaluation speed and the relative rotation speed of the inner ring 2 and the outer ring 3 even in a case where a position where the damage is to occur is unknown.

A revolution cycle To of the rolling element 4 when the rolling element 4 rotationally moves so as to revolve around the central axis of the rotation shaft 5 in the circumferential direction can be expressed with the following expression (20).

$$\begin{matrix}[ Math . 20 ] & \\ To = \frac{2}{{f}_{s}} ( \frac{1}{1 - \frac{d}{D} cos α} ) & ( 20 )\end{matrix}$$

Note that the revolution cycle To of the rolling element 4 can be determined using the relative rotation speed fₛ of the inner ring 2 and the outer ring 3, the diameter d of the rolling element 4, the diameter D of the trajectory of the center of the rolling element 4, and the contact angle α of the rolling element 4. The revolution cycle To is equal to a value obtained by multiplying the cycle Trₒ of the characteristic vibration in a case where damage has occurred to the outer ring 3 by the number Z of the rolling elements 4. Further, concerning the revolution cycle To of the rolling element 4, the following can be understood. The revolution cycle To becomes shorter in inverse proportion as the relative rotation speed fₛ becomes larger. The revolution cycle To becomes shorter as the diameter D of the trajectory of the center of the rolling element 4 becomes larger. The revolution cycle To becomes longer as the diameter d of the rolling element 4 becomes larger. The revolution cycle To becomes shorter as the contact angle & becomes larger. Further, a rotation cycle of a holder that rotationally moves along with the rolling element 4 while keeping an interval among the plurality of rolling elements 4 that rotationally moves so as to revolve around the central axis of the rotation shaft 5 between the inner ring 2 and the outer ring 3 is substantially equal to the revolution cycle To of the rolling element 4 indicated in expression (20).

An area in the circumferential direction in which the rolling element 4 that rotationally moves in the circumferential direction so as to revolve between the inner ring 2 and the outer ring 3 receives a load from the rotation shaft 5 is considered as a loaded zone, and other area is considered as an unloaded zone. In this event, in a case where the damaged portion 100 has occurred in the inner ring 2 or the rolling element 4, the rolling element 4 sinks down in the recessed portion 101 and the evaluation index becomes large only at a timing at which the damaged portion 100 is located in the loaded zone. In other words, in a case where the damaged portion 100 has occurred in the inner ring 2, the evaluation index becomes large at a timing of the cycle Trᵢ of the characteristic vibration that can be calculated by expression (4) within a period during which the damaged portion 100 is located in the loaded zone with a rotation cycle (1/fₛ) that is an inverse of the rotation speed fₛ of the rotation shaft 5 that rotates in an integrated manner with the inner ring 2. On the other hand, in a case where the damaged portion 100 has occurred in the rolling element 4, the evaluation index becomes large at a timing of the cycle Trᵢ of the characteristic vibration that can be calculated with expression (4) within the period during which the damaged portion 100 is located in the loaded zone with the revolution cycle To of the rolling element 4. The contact angle α takes a value in a range from 0 to 90 deg., and the diameter d of the rolling element 4 does not become larger than the diameter D of the trajectory of the center of the rolling element 4. Thus, a factor in brackets in a right side of expression (20) becomes always a value equal to or greater than 1. It can be therefore understood from expression (20) that the revolution cycle To of the rolling element 4 becomes always longer than the rotation cycle (1/fₛ) of the rotation shaft 5. In other words, the evaluation index becomes large at least once within the period equal to or longer than the revolution cycle To of the rolling element 4. The control unit 9 acquires the evaluation speed by the measurement result of the behavior sensor 8 within the period equal to or longer than the revolution cycle To of the rolling element 4. Thus, by diagnosing the damage to the rolling bearing 1 using the evaluation index based on the evaluation speed and the relative rotation speed of the inner ring 2 and the outer ring 3, the control unit 9 including the diagnosis unit 11 can diagnose damage with high accuracy even in a case where a position where the damage is to occur is unknown.

Further, for example, in a case where the relative rotation speed of the inner ring 2 and the outer ring 3 increases or decreases, the control unit 9 may acquire the evaluation speed from the measurement result of the behavior sensor 8 attached to the housing 6 within the period which is equal to or longer than the cycle Tr of the characteristic vibration and in which the maximum value of the relative rotation speed of the inner ring 2 and the outer ring 3 falls within a range of 1.2 times of the minimum value. Within such a period, a temporal change of the relative rotation speed fₛ is suppressed to be small, and expression (19) approximately holds true from expression (7) that assumes a certain relative rotation speed fₛ. Thus, by diagnosing damage to the rolling bearing 1 using the evaluation index based on the evaluation speed and the relative rotation speed of the inner ring 2 and the outer ring 3, the control unit 9 including the diagnosis unit 11 can diagnose the damage with high accuracy even in a case where the relative rotation speed of the inner ring 2 and the outer ring 3 increases or decreases.

Further, the recessed portion 101 often expands also in the shaft direction and in the circumferential direction as the depth in the radial direction becomes larger. Thus, the diagnostic device 7 can diagnose a degree of the damage such as a size and a volume of the recessed portion 101 by diagnosing the depth of the recessed portion 101.

Typically, the rolling bearing is a portion to which the largest load is applied in the rotation equipment and that is likely to break down first. If damage occurs to the rolling bearing, there is a case where the damage may become large at an accelerated rate as a result of stress around the damage becoming large. If the damage becomes large, there is a possibility that breakage of the rolling bearing, damage to or breakage of peripheral equipment of the rolling bearing, a severe failure of the whole rotation equipment in which the rolling bearing is provided, and the like, may occur.

Concerning this, the diagnostic device 7 can diagnose the damage to the rolling bearing 1 with high accuracy, so that it is possible to perform preventive maintenance of the rolling bearing 1. This makes it possible to prevent in advance a failure not only in the rolling bearing 1 itself but also in peripheral equipment of the rolling bearing 1 and the whole rotation equipment in which the rolling bearing 1 is provided.

Further, the diagnosis unit 11 can, for example, provide a diagnosis indicating that damage has occurred to the rolling bearing 1 in a case where the evaluation speed exceeds a threshold set in advance and can provide a diagnosis indicating that a severe damage has occurred in a case where the evaluation speed exceeds a further higher threshold. Further, the diagnosis unit 11 can also diagnose a degree of the damage such as a depth, a size and a volume of the damaged portion 100 in accordance with a value of the evaluation speed.

Concerning the rolling bearing 1 according to the ninth embodiment, a configuration has been described as an example where the inner ring 2 rotates in an integrated manner with the rotation shaft 5, and the outer ring 3 is held and fixed in the housing 6. On the other hand, even in a configuration in which the inner ring 2 is held and fixed in the housing 6, and the outer ring 3 rotates in an integrated manner with the rotation shaft 5 provided outside the outer ring 3, expression (7) to expression (19) which are motion equations when the rolling element 4 sinks down in the recessed portion 101 at least relatively hold true. Thus, the diagnostic device 7 can calculate the evaluation speed that is the maximum speed component in the direction of the load acting on the rolling bearing 1 from the rotation shaft 5 that rotates in an integrated manner with the outer ring 3 using the behavior sensor 8 provided on the inner ring 2 or the housing 6 that holds the inner ring 2 and diagnose the damage to the rolling bearing 1 using the evaluation index based on the evaluation speed and the relative rotation speed of the inner ring 2 and the outer ring 3.

As described above, the rolling bearing 1 according to the ninth embodiment includes the inner ring 2, the outer ring 3, the plurality of rolling elements 4, and the diagnostic device 7. The outer ring 3 is arranged concentrically with the inner ring 2. The plurality of rolling elements 4 is arranged between the raceway surface of the outer ring 3 and the raceway surface of the inner ring 2. Each rolling element 4 rolls in association with rotation of the inner ring 2 or rotation of the outer ring 3. In the rolling bearing 1, the rotation shaft 5 rotates in an integrated manner with the inner ring 2 or the outer ring 3. The diagnostic device 7 includes the behavior sensor 8, the calculation unit 14, and the diagnosis unit 11. The behavior sensor 8 is provided on the outer ring 3 or the housing 6 that holds the outer ring 3 and measures behavior of the outer ring 3 or the housing 6. The calculation unit 14 calculates the evaluation speed based on the information acquired by the behavior sensor 8. The evaluation speed is the maximum speed component in the direction in which the load from the rotation shaft 5 acts within the period equal to or longer than the cycle Tr of the characteristic vibration determined by the specifications of the rolling bearing 1. The diagnosis unit 11 diagnoses the damage to the rolling bearing 1 using the evaluation index based on the evaluation speed calculated by the calculation unit 14 and the relative rotation speed.

As a comparative example, consideration will be given to a case where diagnosis is performed based on an impact value from the vibration sensor, a size of the rolling bearing and the relative rotation speed without depending on the evaluation speed, unlike with in the diagnostic device 7. Note that a unit of the impact value is the same as a unit [mm/sec²] of the acceleration.

In the comparative example, even if a relationship of each speed upon repulsion can be obtained as in expression (11), a relational expression of each impact value cannot be obtained. While the depth h of the recessed portion can be calculated using the radial-direction speed Voᵣ′ of the outer ring or the housing which becomes maximum immediately after the rolling element collides with the recessed portion, a relational expression based on a physical phenomenon between the impact value and the depth h of the recessed portion cannot be obtained. It is therefore difficult to diagnose the damage with high accuracy even if diagnosis is performed based on the impact value from the vibration sensor, the size of the rolling bearing, and the relative rotation speed.

Further, a surface of the damaged portion of the rolling bearing is often rough, and thus, when the rolling element passes through the damaged portion, fine slight impact often occurs a plurality of times. Thus, even if the damaged portion becomes large, the impact value does not become large, and thus, there is a case where the damage cannot be diagnosed with high accuracy by the comparative example using only the impact value.

Further, the impact value becomes large by an instantaneous behavior change, and thus, the impact value does not always become large due to behavior of the rolling element sinking down into the recessed portion, and often becomes significantly large by a minor change in shape such as rough surface or the damaged corner portion. Thus, with the comparative example, while continuous increase of rattling, wobble, or abnormal noise of the rolling bearing, the peripheral equipment of the rolling bearing or the whole rotation equipment in which the rolling bearing is provided, and a minor change in shape which does not directly lead to the remaining lifespans of the rolling bearing and the whole rotation equipment, and the like, can be diagnosed, the comparative example is unsuitable for diagnosis of a size of the recessed portion which directly leads to the remaining lifespans.

For example, the rolling element smoothly passes through the damaged portion if a shape of the damaged corner portion becomes smooth by wear, and the like, and thus, the influence of the damaged portion does not appear in the impact value, and the damage is not detected. Further, for example, in a case where the shape of the damaged corner portion is sharp even if the recessed portion of the damaged portion is small, the impact value may become large at a timing at which the rolling element passes through the damaged corner portion. In this event, vibration can occur in such a manner that the acceleration in the load direction and the acceleration in the anti-load direction, and the like, alternately instantaneously become large. This can increase the acceleration amplitude, the impact value, and the like, regardless of the size of the recessed portion, and thus, it may be difficult to diagnose a degree of the damage itself such as a size of the recessed portion of the damaged portion with high accuracy with the comparative example.

Further, the impact of the rolling bearing can include vibration in a high frequency band caused by friction sliding, and the like. Thus, a magnitude of the impact can change depending on a lubricated condition of the rolling bearing. For example, if the lubricated condition is deteriorated due to oxidation deterioration of grease that lubricates the rolling bearing, oil separation, leak, destruction of a thickening agent, or the like, there is a case where the impact becomes large several times even if damage does not occur to the rolling bearing itself. In this manner, the diagnosis performed based on only the impact value is affected by a change in the lubricated condition of the rolling bearing, and thus, in the comparative example, diagnosis accuracy of the damage to the rolling bearing may decrease.

On the other hand, the diagnostic device 7 performs diagnosis using the evaluation index based on the evaluation speed that is the maximum speed component in the load direction at a timing at which the rolling element 4 sinks down in the recessed portion 101, and the relative rotation speed. The instantaneous behavior occurring when the rolling element 4 passes through the damaged corner portion 102 appears as an instantaneous acceleration amplitude. If such an instantaneous acceleration change is time-integrated, the acceleration whose positive/negative direction is instantaneously reversed is cancelled out by the integration, and thus, the speed does not become large when the rolling element 4 passes through the damaged corner portion 102. On the other hand, the direction of the acceleration becomes continuously the load direction at a timing at which the rolling element 4 sinks down in the recessed portion 101, and thus, the evaluation speed that is the maximum speed component in the load direction obtained through the integration becomes sufficiently large. In other words, the diagnostic device 7 according to the ninth embodiment that performs diagnosis using the evaluation speed can diagnose a size of the recessed portion 101 with high accuracy while suppressing influence of instantaneous behavior of the rolling element 4 by the shape of the damaged corner portion 102. Further, the maximum speed component in the load direction becomes larger as the depth of the recessed portion 101 is larger. The diagnostic device 7 using the evaluation speed that has a strong correlation with the depth of the recessed portion 101 in this manner can diagnose a degree of the depth of the recessed portion 101. Further, the recessed portion 101 often expands in the shaft direction and in the circumferential direction as the depth in the radial direction becomes larger. Thus, the diagnostic device 7 can diagnose a degree of the damage such as the size and the volume of the recessed portion 101 by diagnosing the depth of the recessed portion 101.

Further, the evaluation speed becomes large by a geometric shape of the recessed portion 101. Thus, unlike with a device that performs diagnosis using vibration including a high frequency band caused by friction sliding, the diagnostic device 7 can diagnose the damage to the rolling bearing 1 with high accuracy while suppressing influence of the lubricated condition and turbulence such as turbulence vibration.

### Tenth Embodiment

An example of diagnosis of damage to the rolling bearing 1 by the diagnostic device 7 according to a tenth embodiment will be described. In the diagnostic device 7 according to the tenth embodiment, the diagnosis unit 11 diagnoses the damage to the rolling bearing 1 using a relative evaluation speed obtained by dividing the evaluation speed by the relative rotation speed as the evaluation index.

The inventors have studied hard using data of a plurality of actual products and test data and have achieved inference that the evaluation speed becomes large in proportion to the relative rotation speed even in the same damage condition. In other words, to evaluate and compare degrees of the damage to the rolling bearing 1 in a condition where the relative rotation speed is different, it is necessary to perform diagnosis while taking into account influence of the relative rotation speed as well as the evaluation speed. With the diagnostic device 7 according to the tenth embodiment, it is possible to diagnose the degree of the damage to the rolling bearing 1 regardless of the relative rotation speed by using the relative evaluation speed obtained by dividing the evaluation speed by the relative rotation speed as the evaluation index.

An example of diagnosis using the motion equation when the rolling element 4 sinks down in the recessed portion 101 will be indicated. If the relative evaluation speed (Voᵣ′/fₛ) obtained by dividing the evaluation speed Voᵣ′ by the relative rotation speed fₛ of the rotation shaft 5 in a right side of expression (19) is considered as the evaluation index, the depth h of the recessed portion 101 can be calculated with a constant determined by each mass, and a shape and a dimension of the rolling bearing 1, and the evaluation index that is the relative evaluation speed (Voᵣ′/fₛ). In other words, by using the evaluation index that is the relative evaluation speed (Voᵣ′/fₛ), the diagnostic device 7 can obtain the depth h of the recessed portion 101 for the rolling bearing 1. Further, the recessed portion 101 often expands in the shaft direction and in the circumferential direction as the depth in the radial direction becomes larger. Thus, the diagnostic device 7 can also diagnose the degree of the damage to the recessed portion 101 by diagnosing the depth h of the recessed portion 101. In other words, it is possible to diagnose the degree of the damage to the rolling bearing using the evaluation index that is the relative evaluation speed (Voᵣ′/fₛ).

Even if the relative rotation speed of the inner ring 2 and the outer ring 3 in a time section during which the evaluation speed to be used in diagnosis is measured, is not measured, there is a case where this can be grasped in advance as a design matter. In this case, the diagnostic device 7 can diagnose the damage to the rolling bearing 1 using the evaluation speed in the time section and the evaluation index based on the known relative rotation speed.

Further, even in a case where an absolute value of the relative rotation speed is not grasped in advance, in a case where multiplying factors of the relative rotation speeds can be grasped in two or more time sections, the diagnostic device 7 can diagnose the damage to the rolling bearing 1 based on the evaluation index obtained by dividing the evaluation speeds in the respective time sections by the respective multiplying factors. For example, the evaluation speed in a time section A during which a total number of rotations of the rolling bearing 1 is small is defined as Va, and the evaluation speed in a time section B during which a total number of rotations of the rolling bearing 1 is large is defined as Vb. In a case where it is known that the relative rotation speed in the time section A is twice the relative rotation speed in the time section B, the diagnostic device 7 can diagnose the damage to the rolling bearing 1 while setting the evaluation index in the time section A as Va and setting the evaluation index in the time section B as Vb/2. For example, in a case where a difference between Vb/2 and Va is smaller than a range set in advance, the diagnostic device 7 can provide a diagnosis indicating that the damage does not become large in association with increase in the total number of rotations of the rolling bearing 1. On the other hand, in a case where Vb/2 is larger than Va, the diagnostic device 7 can provide a diagnosis indicating that the damage becomes large in association with increase in the total number of rotations of the rolling bearing 1. Further, for example, in a case where it is known that there is little difference between the relative rotation speed in the time section A and the relative rotation speed in the time section B, the diagnostic device 7 can diagnose the damage to the rolling bearing 1 while setting the evaluation index in the time section A as Va and setting the evaluation index in the time section B as Vb. For example, in a case where a difference between Vb and Va is smaller than a range set in advance, the diagnostic device 7 can provide a diagnosis indicating that the damage does not become large in association with increase in the total number of rotations of the rolling bearing 1. On the other hand, in a case where Vb is larger than Va, the diagnostic device 7 can provide a diagnosis indicating that the damage becomes large in association with increase in the total number of rotations of the rolling bearing 1.

### Eleventh Embodiment

An example of diagnosis of damage to the rolling bearing 1 by the diagnostic device 7 according to an eleventh embodiment will be described. In the diagnostic device according to the eleventh embodiment, the diagnosis unit 11 diagnoses a size of the damage to the rolling bearing 1 based on the evaluation index and a specific coefficient of the rolling bearing 1.

The inventors have studied hard using data of a plurality of actual products and test data and have achieved inference that if the specific coefficient of the rolling bearing 1 changes in accordance with a type, a use condition, and the like, of the rolling bearing 1, the evaluation index changes even in the same damage condition. In other words, to evaluate and compare a degree of the damage to the rolling bearing 1 in a condition where the specific coefficient of the rolling bearing 1 is different, it is necessary to perform diagnosis while also taking into account influence of the specific coefficient of the rolling bearing 1. The diagnostic device 7 according to the eleventh embodiment can diagnose the size of the damage to the rolling bearing 1 with high accuracy by using the evaluation index and the specific coefficient of the rolling bearing 1.

Further, the inventors have studied hard using data of a plurality of actual products and test data and have achieved inference that even if the size of the damage to the rolling bearing 1 does not change, the evaluation index becomes larger in accordance with a shape or the size of a dimension of the rolling bearing 1. In other words, to evaluate and compare a degree of the damage to the rolling bearing 1 in a condition where the shape or the size of the dimension of the rolling bearing 1 is different, it is necessary to perform diagnosis while also taking into account influence of the shape or the size of the dimension of the rolling bearing 1. In the diagnostic device according to the eleventh embodiment, it is possible to diagnose the size of the damage to the rolling bearing 1 with high accuracy by using the evaluation index and the specific coefficient determined based on the shape or the dimension of the rolling bearing 1.

An example of diagnosis using the motion equation when the rolling element 4 sinks down in the recessed portion 101 will be described. The calculation unit 14 can calculate the depth h of the recessed portion 101 from expression (19), and the like, using the specific coefficient of the rolling bearing 1, and the relative evaluation speed (Voᵣ′/fₛ) obtained by dividing the evaluation speed by the relative rotation speed. Here, the specific coefficient of the rolling bearing 1 includes various kinds of amounts such as the diameter d of the rolling element 4, the diameter D of the trajectory of the center of the rolling element 4, the mass m of all the structures which are structures that apply the load to the recessed portion 101 via the rolling element 4 and which include the rolling element 4, the inner ring 2 and the rotation shaft 5, the load acting on the rolling bearing 1 from the rotation shaft 5 corresponding to this, and the mass mₒ of the structure that moves in coordination with the recessed portion 101, for example, indicated in the right side of expression (19), and a coefficient A calculated from these, and the like. The diagnosis unit 11 of the diagnostic device 7 can, for example, provide a diagnosis indicating that the depth h of the recessed portion 101 is larger as the evaluation index that is the relative evaluation speed (Voᵣ′/fₛ) is larger. Further, the diagnostic device 7 can, for example, calculate from expression (19) that the evaluation index becomes larger as the specific coefficient A is smaller even if the depth h of the recessed portion 101 is the same. In this manner, the diagnostic device 7 can diagnose the depth h of the recessed portion 101, the size of the damage to the recessed portion 101, and the like, with high accuracy by using the evaluation index and the specific coefficient based on the shape, the dimension, and the like, of the rolling bearing 1.

### Twelfth Embodiment

An example of diagnosis of damage to the rolling bearing 1 by the diagnostic device 7 according to a twelfth embodiment will be described. In the diagnostic device 7 according to the twelfth embodiment, the diagnosis unit 11 diagnoses the size of the damage to the rolling bearing 1 based on the evaluation index and the diameter D of the trajectory of the center of the rolling element 4.

The inventors have studied hard using data of a plurality of actual products and test data and have achieved inference that even if the size of the damage to the rolling bearing 1 does not change, the evaluation index becomes larger as the diameter D of the trajectory of the center of the rolling element 4 becomes larger. In other words, to evaluate and compare a degree of the damage to the rolling bearing 1 in a condition where the diameter D of the trajectory of the center of the rolling element 4 is different, it is necessary to perform diagnosis while also taking into account influence of the size of the diameter D of the trajectory of the center of the rolling element 4. The diagnostic device 7 according to the twelfth embodiment can diagnose the size of the damage to the rolling bearing 1 with high accuracy based on the evaluation index and the diameter D of the trajectory of the center of the rolling element 4.

An example of diagnosis using the motion equation when the rolling element 4 sinks down in the recessed portion 101 will be described. It can be understood from expression (19) that the specific coefficient A becomes smaller as the diameter D of the trajectory of the center of the rolling element 4 becomes larger. In other words, it can be calculated also from expression (19) that even if the depth h of the recessed portion 101 is the same, the evaluation index can become larger as the diameter D of the trajectory of the center of the rolling element 4 becomes larger. In other words, the diagnostic device 7 can diagnose the depth h of the recessed portion 101 and the size of the damage to the recessed portion 101 with high accuracy by using the evaluation index and the diameter D of the trajectory of the center of the rolling element 4.

### Thirteenth Embodiment

An example of diagnosis of damage to the rolling bearing 1 by the diagnostic device 7 according to a thirteenth embodiment will be described. In the diagnostic device according to the thirteenth embodiment, the diagnosis unit 11 diagnoses a size of the damage to the rolling bearing 1 based on the evaluation index and the load acting on the rolling bearing 1 from the rotation shaft 5.

The inventors have studied hard using data of a plurality of actual products and test data and have achieved inference that even if the size of the damage to the rolling bearing 1 does not change, the evaluation index becomes larger as the load acting on the rolling bearing 1 becomes larger. In other words, to evaluate and compare a degree of the damage to the rolling bearing 1 in a condition where the load acting on the rolling bearing 1 is different, it is necessary to perform diagnosis while also taking into account influence of the load acting on the rolling bearing 1. The diagnostic device 7 according to the thirteenth embodiment can diagnose the size of the damage to the rolling bearing 1 with high accuracy based on the evaluation index and the load acting on the rolling bearing 1.

An example of diagnosis using the motion equation when the rolling element 4 sinks down in the recessed portion 101 will be described. The specific coefficient A in the right side of expression (19) is a coefficient based on a mass ratio (mₒ/m) of the mass mₒ of the structure that moves in coordination with the recessed portion 101 to the mass m of all the structures which are structures that apply the load to the recessed portion 101 via the rolling element 4 and which include the rolling element 4, the inner ring 2 and the rotation shaft 5. In other words, the diagnostic device 7 can diagnose the depth h of the recessed portion 101 with high accuracy by using the evaluation index and the specific coefficient based on this mass ratio. Further, the diagnostic device 7 can diagnose the size of the damage to the rolling bearing 1 with high accuracy.

Here, the mass m has a proportional relation with the load acting on the rolling bearing 1 from the rotation shaft 5, and mₒ often corresponds to a mass of a structure that supports the rolling bearing 1. If the mass ratio (mₒ/m) is too small, there is a concern that strength of the structure that supports the rolling bearing 1 may decrease. Further, inversely, if the mass ratio (mₒ/m) is too large, the weight and the size of the rotation equipment including this rolling bearing 1 become large, which makes design difficult in terms of migration efficiency of the rotation equipment and due to limitations of space where the rotation equipment is provided. In other words, the mass ratio (mₒ/m) is substantially uniquely determined in accordance with the load acting on the rolling bearing 1 by the strength, the migration efficiency, limitations of space where the rotation equipment is provided, and the like. Thus, the specific coefficient A can be considered as a coefficient based on the load acting on the rolling bearing 1. In other words, the diagnostic device 7 can diagnose the depth h of the recessed portion 101 with high accuracy by using the evaluation index and the specific coefficient A based on the load acting on the rolling bearing 1. Further, the diagnostic device 7 can diagnose the size of the damage to the rolling bearing 1 with high accuracy.

### Fourteenth Embodiment

An example of diagnosis of damage to the rolling bearing 1 by the diagnostic device 7 according to a fourteenth embodiment will be described. In the diagnostic device 7 according to the fourteenth embodiment, the diagnosis unit 11 diagnoses the size of the damage to the rolling bearing 1 based on the evaluation index, a maximum displacement of the outer ring 3 or the housing 6 that holds the outer ring 3, and the load acting on the rolling bearing 1 from the rotation shaft 5. Here, the maximum displacement of the outer ring 3 or the housing 6 is a maximum displacement in a direction in which the load from the rotation shaft 5 acts within a period equal to or longer than the cycle of the characteristic vibration determined by the specifications of the rolling bearing 1.

A mass of the structure that moves in coordination with the recessed portion 101 is defined as mₒ [kg], a radial-direction maximum speed of the structure within the period equal to or longer than the cycle of the characteristic vibration determined by the specifications of the rolling bearing 1 is defined as Voᵣ′ [mm/sec], a radial-direction maximum displacement of the structure is defined as Xₘₐₓ [mm], and spring rigidity of the structure with respect to the displacement is defined as k [N/mm]. A radial-direction speed of the structure that moves in coordination with the recessed portion 101 becomes maximum immediately after the rolling element 4 sinks down in and collides with the recessed portion 101, and the structure has motion energy [N·mm]. Then, the motion energy is converted into elastic energy [N·mm] of the structure, and a speed of the structure becomes zero at a timing at which the structure is displaced by the maximum displacement Xₘₐₓ. A law of energy conservation in this event can be expressed with the following expression (21).

$$\begin{matrix}[ Math . 21 ] & \\ \frac{1}{2} {m}_{o} {Vo}_{r}^{′2} = \frac{1}{2} k {X}_{max}^{2} & ( 21 )\end{matrix}$$

The spring rigidity k with respect to the displacement of the structure that moves in coordination with the recessed portion 101 can be obtained as a value obtained by dividing a test load by a measured displacement through measurement of a displacement when a load is applied on an exploratory basis in advance. Alternatively, the spring rigidity k can be also obtained as a value obtained by dividing an assumed load by an assumed displacement which is obtained with respect to the assumed load through manual calculation or using an analysis tool such as CAD from a material of the structure, a structure, a constraint condition, and the like. In other words, if the radial-direction maximum speed Voᵣ′ and the maximum displacement Xₘₐₓ of the structure are measured, the mass mₒ can be obtained from expression (21). By using this, the diagnostic device 7 can diagnose the depth h of the recessed portion 101 with higher accuracy from expression (19).

Among the structures that move in coordination with the recessed portion 101, the speed and the displacement tend to be the largest in the outer ring 3 and the housing 6 that holds the outer ring 3 of the rolling bearing 1, which receive the load from the rotation shaft 5 at the closest position. The outer ring 3 and the housing 6 move substantially in an integrated manner, and thus, the radial-direction maximum speed Voᵣ′ and the maximum displacement Xₘₐₓ of the structure can be grasped as the radial-direction maximum speed and the maximum displacement of the outer ring 3 or the housing 6. Here, in a case where the behavior sensor 8 is an acceleration sensor, the calculation unit 14 can calculate time-series data of the displacement by performing second-order time integration on the time-series data of the acceleration that is the output signal from the behavior sensor 8. The calculation unit 14 can obtain the maximum displacement Xₘₐₓ of the outer ring 3 or the housing 6 from this time-series data. Further, in a case where the behavior sensor 8 is a speed sensor, the calculation unit 14 can calculate time-series data of the displacement by performing time integration on time-series data of the speed that is the output signal from the behavior sensor 8. The calculation unit 14 can obtain the maximum displacement Xₘₐₓ of the outer ring 3 and the housing 6 from this time-series data. Further, in a case where the behavior sensor 8 is a displacement sensor, the calculation unit 14 can obtain the maximum displacement Xₘₐₓ from time-series data of the displacement that is the output signal from the behavior sensor 8. In other words, the calculation unit 14 can calculate the radial-direction maximum speed Voᵣ′ and the maximum displacement Xₘₐₓ of the outer ring 3 or the housing 6 based on the output signal from the behavior sensor 8. Further, the diagnostic device 7 can obtain the mass mₒ of the structure that moves in coordination with the recessed portion 101 from expression (21). The diagnostic device 7 can diagnose the depth h of the recessed portion 101 with higher accuracy from expression (19), and the like. Further, the diagnostic device 7 can diagnose a size of the damage to the rolling bearing 1 with high accuracy.

### Fifteenth Embodiment

An example of diagnosis of damage to the rolling bearing 1 by the diagnostic device 7 according to a fifteenth embodiment will be described. In the diagnostic device 7 according to the fifteenth embodiment, the diagnosis unit 11 diagnoses a size of the damage to the rolling bearing 1 based on the evaluation index, actually measured data indicating the size of the damage to the rolling bearing 1 and data of the evaluation index in the condition.

An example of diagnosis using the motion equation when the rolling element 4 sinks down in the recessed portion 101 will be described. By using expression (19), the depth h of the recessed portion 101 can be calculated by the relative evaluation speed (Voᵣ′/fₛ) obtained by dividing the evaluation speed by the relative rotation speed, and the specific coefficient of the rolling bearing 1. Thus, for example, by preparing at least one of the actually measured data indicating the size of the damage such as the depth h of the recessed portion 101 and data of the evaluation index in the condition, the specific coefficient can be obtained from expression (19). In this manner, by using the specific coefficient obtained based on the actually measured data, and the evaluation index, even in a case where there is no design data required for obtaining the specific coefficient, the diagnostic device 7 can diagnose the depth h of the recessed portion 101 with high accuracy. Further, the diagnostic device 7 can diagnose the size of the damage to the rolling bearing 1 with high accuracy.

### Sixteenth Embodiment

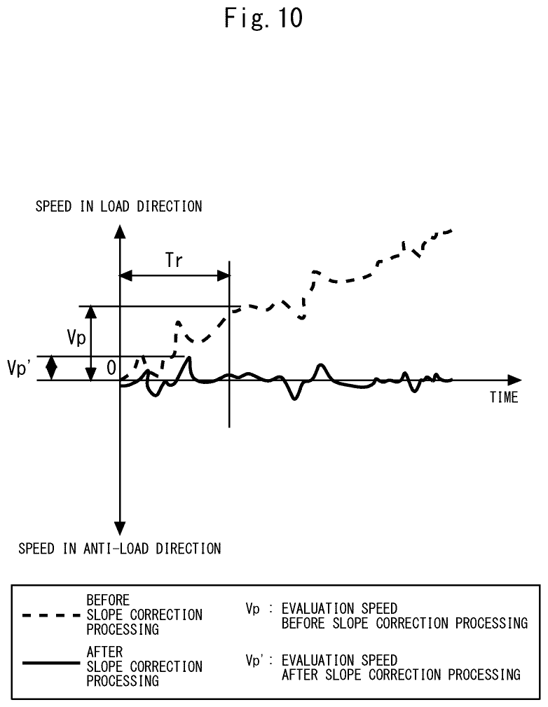

FIG. 10 is a diagram for explaining an example of diagnosis of damage to the rolling bearing 1 by the diagnostic device 7 according to a sixteenth embodiment. FIG. 10 indicates transition of time on a horizontal axis. FIG. 10 indicates a speed acquired by the behavior sensor 8 on a vertical axis. An upper side on the vertical axis indicates the magnitude of a speed in the load direction. On the other hand, a lower side on the vertical axis indicates the magnitude of a speed in the anti-load direction.

For example, in a case where the time-series data of the speed is calculated by performing time integration on the time-series data of the acceleration using the acceleration sensor as the behavior sensor 8, as indicated by a dashed line in FIG. 10, the speed may become extremely large in the load direction over a period longer than the cycle Tr. This occurs as a result of, in a case where an attachment condition of the behavior sensor 8 that is the acceleration sensor is poor, in a case where noise such as other turbulence vibration is largely reflected, and the like, the time-series data of the acceleration that is the output signal being wholly shifted in the load direction. For a similar reason, the speed may become large in the anti-load direction over a period longer than the cycle Tr.

On the other hand, even if minor vibration may occur in the rolling bearing 1 and the housing 6, normally, positions where the rolling bearing 1 and the housing 6 are provided do not largely change. Thus, continuous increase of the speed over a long period as indicated by a dashed line in FIG. 10 is different from an actual condition, and if such time-series data is used as is, the evaluation speed Vp is calculated as an excessive value. The diagnostic device 7 therefore performs slope correction on the time-series data of the speed.

The calculation unit 14 of the diagnostic device 7 performs slope correction processing on the time-series data of the speed based on the information acquired by the behavior sensor 8. The slope correction processing is performed by, for example, obtaining a slope component of the time-series data of the speed through linear regression or other methods over the period longer than the cycle Tr and subtracting the obtained slope component from the time-series data of the speed. The calculation unit 14 calculates the evaluation speed Vp′ for the period longer than the cycle Tr using the time-series data of the speed subjected to the slope correction processing.

The diagnostic device 7 can diagnose a degree and a size of the damage to the rolling bearing without being affected by the attachment condition of the behavior sensor 8 and noise such as turbulence vibration by using the evaluation speed Vp′ calculated in this manner.

### Seventeenth Embodiment

An example of diagnosis of damage to the rolling bearing by the diagnostic device 7 according to a seventeenth embodiment will be described. The diagnosis unit 11 of the diagnostic device 7 diagnoses the damage to the rolling bearing 1 by using an evaluation index statistic. The evaluation index statistic is calculated for periods obtained by separating a period longer than a revolution cycle of the rolling element 4 when the rolling element 4 rotationally moves in the circumferential direction around the central axis of the rotation shaft 5, into a plurality of periods each equal to or longer than the cycle of the characteristic vibration. The evaluation index statistic can be obtained by performing statistical processing on a data group of a plurality of evaluation indexes calculated within the separated plurality of periods.

A revolution cycle To of the rolling element 4 when the rolling element 4 rotationally moves so as to revolve in the circumferential direction around the central axis of the rotation shaft 5 is expressed with expression (20). Note that the revolution cycle To of the rolling element can be determined using the relative rotation speed fₛ of the inner ring 2 and the outer ring 3, the diameter d of the rolling element 4, the diameter D of the trajectory of the center of the rolling element 4, and the contact angle α of the rolling element 4. The revolution cycle To is the same value as a value obtained by multiplying the cycle Trₒ of the characteristic vibration in a case where a damage has occurred to the outer ring 3 by the number Z of the rolling elements 4. Further, the following is understood for the revolution cycle To of the rolling element 4. The revolution cycle To of the rolling element 4 becomes shorter in inverse proportion to increase of the relative rotation speed fₛ. The revolution cycle To of the rolling element 4 becomes shorter as the diameter D of the trajectory of the center of the rolling element 4 becomes larger. The revolution cycle To of the rolling element 4 becomes longer as the diameter d of the rolling element 4 becomes larger. The revolution cycle To of the rolling element 4 becomes shorter as the contact angle α becomes larger. Further, a rotation cycle of a holder that rotationally moves along with the rolling element 4 while keeping an interval among the plurality of rolling elements 4 that rotationally moves so as to revolve around the central axis of the rotational shaft 5 between the inner ring 2 and the outer ring 3 is also substantially the same as the revolution cycle To of the rolling element 4 indicated in expression (20).

The holder and the rolling element 4 freely move within a range of clearance inside the rolling bearing 1 depending on a constraint condition. In a case where the interval among the plurality of rolling elements 4 is not uniform, in a case where the center of the holder is shifted from the central axis of the rotation shaft 5, and in a case where damage such as wear or a scar has occurred to part of the holder and the rolling element 4 and symmetric property of the shape is lost, vibration occurring when each rolling element 4 passes through the damaged portion 100 may have periodicity with the revolution cycle To of the rolling element 4. This is because when the rolling element 4 passes through the damaged portion 100 at a specific position in the circumferential direction of the holder in which the above-described non-uniformity, shift, damage, or the like, has occurred, or when a specific rolling element 4 in which the above-described non-uniformity, shift, damage, or the like, has occurred passes through the damaged portion 100, values of a shape and a dimension of the rolling bearing 1, a mass, a load, a speed, and the like, to be used from expression (7) to expression (19), and the like, change.

Thus, to measure cyclic vibration at least once in the revolution cycle To of the rolling element 4, the period longer than the revolution cycle To of the rolling element 4 is separated into a plurality of periods each equal to or longer than the cycle Tr of the characteristic vibration determined by the specifications of the rolling bearing 1 and the relative rotation speed of the inner ring 2 and the outer ring 3. By using the evaluation index statistic obtained by calculating the evaluation index within each of the separated periods and performing statistical processing on a data group of a plurality of evaluation indexes obtained in the number equal to the separated periods, the diagnostic device 7 can diagnose a degree of the damage to the rolling bearing 1 with high accuracy.

The evaluation index statistic is, for example, an average value, a median value, an effective value, a maximum value, or the like, for the data group of the evaluation indexes. The diagnosis unit 11, for example, provides a diagnosis indicating that damage has occurred to the rolling bearing 1 when the evaluation index statistic exceeds a threshold set in advance.

Further, for example, each value of the evaluation index for each time calculated by the calculation unit 14, and the like, may take an extremely large value as a result of, for example, the behavior sensor 8 capturing sudden turbulence vibration, or the like, which is irrelevant to the damage to the rolling bearing 1. According to the configuration of the seventeenth embodiment, the diagnosis unit 11 performs diagnosis using the evaluation index statistic such as the average value, the median value, the effective value, or the like, obtained by performing statistical processing on the data group of the evaluation indexes, and thus, the diagnostic device 7 can perform diagnosis with high accuracy without being affected by a sudden event which is irrelevant to the damage to the rolling bearing 1.

Further, for example, there is a case where the evaluation index may become large with low frequency in a stage in which the damage to the rolling bearing 1 is small. Concerning this, the diagnosis unit 11 performs diagnosis using the evaluation index statistic such as a maximum value obtained by performing statistical processing on the data group of the evaluation indexes, so that the diagnostic device 7 can diagnose the damage early also in a stage in which the damage is small.

Further, for example, while there is a case where the average value, or the like, of the evaluation indexes may rapidly change in a condition where the damage to the rolling bearing 1 rapidly progresses, time-series variation of the evaluation indexes often becomes large in the previous stage as a presage of such a rapid change of the condition. By using the evaluation index statistic indicating time-series variation such as a standard deviation value or a variance value obtained by performing statistical processing on the data group of the evaluation indexes, the diagnostic device 7 can diagnose a progress condition of the damage early with high accuracy.

### Eighteenth Embodiment

An example of diagnosis of damage to the rolling bearing 1 by the diagnostic device 7 according to an eighteenth embodiment will be described. The diagnosis unit 11 of the diagnostic device 7 diagnoses the damage to the rolling bearing 1 based on a cyclic change of the evaluation index which is continuously calculated to obtain temporally successive evaluation indexes.

For example, the evaluation index becomes large at a timing at which the rolling element 4 passes through the damaged portion 100 in the time-series data of the evaluation index calculated by the diagnosis unit 11, and the like, and this cycle substantially coincides with the cycle Tr of the characteristic vibration determined by the specifications of the rolling bearing 1. On the other hand, the cycle of the rolling element 4 passing through the damaged portion 100 is determined from expression (4) to expression (6) using a position where the damaged portion 100 has occurred, a dimension of the rolling bearing 1, the relative rotation speed, and the like. Thus, the diagnosis unit 11 can determine whether the damaged portion 100 has occurred in any position of the inner ring 2, the outer ring 3 or the rolling element 4 of the rolling bearing 1 based on the dimension of the rolling bearing 1 and the relative rotation speed from a cycle, a frequency, or the like, in which the evaluation index becomes large. Note that while FIG. 8 illustrates an example where the damaged portion 100 has occurred in the outer ring 3, even if the damaged portion 100 has occurred in the inner ring 2 or the rolling element 4, expression (7) to expression (19) which are motion equations when the rolling element 4 sinks down in the recessed portion 101, at least relatively hold true. Thus, in a similar manner to a case where the damaged portion 100 has occurred in the outer ring 3, the diagnostic device 7 can calculate the depth h of the recessed portion 101.

An area in the circumferential direction in which the rolling element 4 that rotationally moves in the circumferential direction so as to revolve between the inner ring 2 and the outer ring 3 receives a load from the rotation shaft 5 is considered as a loaded zone, and other area is considered as an unloaded zone. In this event, in a case where the damaged portion 100 has occurred in the inner ring 2 or the rolling element 4, the rolling element 4 sinks down in the recessed portion 101 and the evaluation index becomes large only at a timing at which the damaged portion 100 is located in the loaded zone. In other words, in a case where the damaged portion has occurred in the inner ring 2, the evaluation index becomes large at a timing of the cycle Trᵢ of the characteristic vibration calculated by expression (4) within a period during which the damaged portion 100 is located in the loaded zone with a rotation cycle (1/fₛ) which is an inverse of the rotation speed fₛ of the rotation shaft that rotates in an integrated manner with the inner ring 2. On the other hand, in a case where the damaged portion 100 has occurred in the rolling element 4, the evaluation index becomes large at a timing of the cycle Trᵢ of the characteristic vibration calculated by expression (4) within a period during which the damaged portion 100 is located in the loaded zone with the revolution cycle To of the rolling element 4. Thus, the diagnosis unit 11 can diagnosis a position among the inner ring 2, the rolling element 4 and the outer ring 3, where the damaged portion 100 has occurred by obtaining a time cycle in which the damaged portion 100 is located in the loaded zone from the cycle in which the evaluation index becomes large. Further, even in a case where the damaged portion 100 has occurred at a plurality of positions, the diagnosis unit 11 can determine at how many positions the damaged portion 100 has occurred. Further, the diagnosis unit 11 can determine a position among the inner ring 2, the outer ring 3 and the rolling element 4 of the rolling bearing 1 where each of the plurality of damaged portions 100 has occurred.

Further, the diagnosis unit 11 may diagnose the size of the damaged portion 100 based on the evaluation index in the cycle in which the evaluation index becomes large. This enables the diagnosis unit 11 to diagnose the depth of the recessed portion 101 or the size of the damaged portion 100 with high accuracy without being affected by noise such as turbulence vibration. The diagnosis unit 11 may, for example, diagnose the position where the damaged portion 100 has occurred from a frequency band in which spectral intensity is large for frequency analysis data obtained by performing frequency analysis on the time-series data of the evaluation index. For example, the diagnosis unit 11 may diagnose a position where the damaged portion 100 has occurred as follows by comparing spectral intensity in specific frequency bands that are inverses of the cycles Tr defined from expression (4) to expression (6). The diagnosis unit 11 provides a diagnosis indicating that the damaged portion 100 has occurred in the inner ring 2 in a case where the frequency band with large spectral intensity is the closest to the inverse of the cycle Trᵢ of expression (4) among the inverses of the cycles Tr from expression (4) to expression (6). The diagnosis unit 11 provides a diagnosis indicating that the damaged portion 100 has occurred in the outer ring 3 in a case where the frequency band with large spectral intensity is the closest to the inverse of the cycle Trₒ of expression (5) among the inverses of the cycles Tr from expression (4) to expression (6). The diagnosis unit 11 provides a diagnosis indicating that the damaged portion 100 has occurred in the inner ring 2 in a case where the frequency band with large spectral intensity is the closest to the inverse of the cycle Tr_{b} of expression (6) among the inverses of the cycles Tr from expression (4) to expression (6).

Further, while the evaluation index becomes large at a timing at which the rolling element 4 periodically passes through the damaged portion 100, the evaluation index may become large at other timings by being affected by turbulence vibration. The diagnosis unit 11 can perform diagnosis with high accuracy while suppressing influence of noise such as turbulence vibration by diagnosing the depth of the recessed portion 101 or the size of the damaged portion 100 from the spectral intensity in a specific frequency band in which the rolling element 4 passes through the damaged portion 100.

### Nineteenth Embodiment

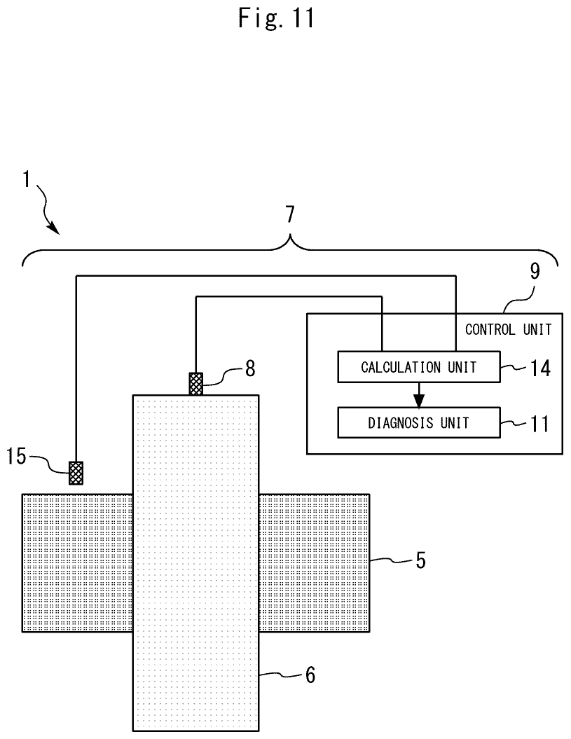

FIG. 11 is a configuration diagram of the rolling bearing 1 according to a nineteenth embodiment.

In the nineteenth embodiment, the diagnostic device 7 of the rolling bearing 1 includes a rotation sensor 15.

The rotation sensor 15 may be a sensor that directly measures rotation speeds, rotational angular speeds, and the like, of the inner ring 2, the outer ring 3, the rotation shaft 5 integrated with the inner ring 2 or the outer ring 3, the rolling element 4, the holder, and the like, by utilizing laser, light, a microwave, an ultrasonic wave, a magnetic sensor, and the like. The rotation sensor 15 may be a sensor integrated with rotation equipment such as a motor. The rotation sensor 15 integrated with the rotation equipment, for example, measures an output value such as a current value of the motor and calculates a rotation speed of the rotation shaft 5 from the output value.

According to the configuration of the nineteenth embodiment, the diagnostic device 7 can diagnose the damage to the rolling bearing 1 with high accuracy by measuring a relative rotation speed using the rotation sensor 15. For example, even in a case where the rotation speed of the rotation shaft 5 changes, by measuring a relative rotation speed of the inner ring 2 and the outer ring 3 in a time section during which the evaluation speed used for diagnosis has been measured, the diagnostic device 7 can always diagnose the damage to the rolling bearing 1 with high accuracy.

### Twentieth Embodiment

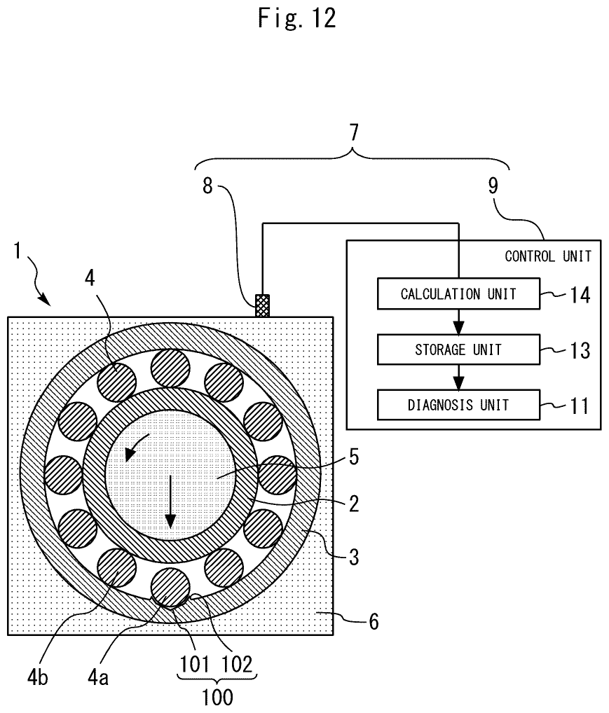

FIG. 12 is a configuration diagram of the rolling bearing 1 according to a twentieth embodiment.

In the twentieth embodiment, the control unit 9 of the diagnostic device 7 of the rolling bearing 1 includes the calculation unit 14, the storage unit 13, and the diagnosis unit 11.

The storage unit 13 is a portion having a function of storing information. The storage unit 13 accumulates and stores the calculated evaluation index. The storage unit 13 stores, for example, time-series data of the evaluation index. The storage unit 13 may store time-series data of the evaluation speed to be used for calculation of the evaluation index. The storage unit 13 stores a temporal change of the evaluation index by storing the evaluation index as the time-series data. Further, the storage unit 13 may store a change amount from the evaluation index calculated last time.

Here, in rotation equipment in which a plurality of rolling bearings 1 with different specification conditions such as a specific coefficient, a shape, a dimension, a relative rotation speed, and a load acting on the rolling bearing 1 from the rotation shaft 5, is provided, even if sizes of damages occurring to the respective rolling bearings 1 are the same, the evaluation index may take different values depending on a difference in use condition. For example, as the diameter of the trajectory of the center of the rolling element 4, the relative rotation speed, the load acting on the rolling bearing 1 from the rotation shaft 5, and the like, are larger, the evaluation index tends to be larger for the damage of the same degree.

On the other hand, a time-differential value of the evaluation index that is a temporal change rate of the evaluation index often has a one-to-one correlation relation with a degree of the damage to the rolling bearing 1 also for the rolling bearings 1 with different specification conditions such as a specific coefficient, a shape, a dimension, a relative rotation speed, and a load acting on the rolling bearing 1 from the rotation shaft 5. In other words, even in the rolling bearings 1 with different specification conditions, if the time-differential values of the evaluation indexes are the same degree, the diagnostic device 7 can provide a diagnosis indicating that the damages are the same degree. Alternatively, when the time-differential value of the evaluation index exceeds a stable value, the diagnostic device 7 can diagnose this as a presage leading to loss of a function of the rolling bearing 1 or the whole rotation equipment including the rolling bearing 1, such as a failure such as a crack in or breakage of the rolling bearing 1, and a failure of peripheral equipment of the rolling bearing 1. In other words, the diagnosis unit 11 can calculate a period until occurrence of the damage leading to loss of the function of the rolling bearing 1 or the whole rotation equipment including the rolling bearing 1 based on the evaluation index stored in the storage unit 13 or the temporal change rate of the evaluation index calculated by the information stored in the storage unit 13. This enables the diagnosis unit 11 to calculate an appropriate maintenance and check time and replacement time of the rolling bearing 1 to prevent in advance the damage that leads to loss of functions. In this manner, the diagnostic device 7 can contribute to labor saving of maintenance and long-term stable operation of the rolling bearing 1, the peripheral equipment of the rolling bearing 1 and the whole rotation equipment in which the rolling bearing 1 is provided.

### Twenty-First Embodiment

The rolling bearing 1 includes the inner ring 2, the outer ring 3, the plurality of rolling elements 4, the rotation shaft 5, and the diagnostic device 7.

Typically, the rolling bearing is a portion to which the largest load is applied in the rotation equipment and that is likely to break down first. If a damage has occurred to the rolling bearing, there is a case where the damage may become large at an accelerated rate as a result of stress around the damage becoming large. If the damage becomes large, behavior of the whole rotation equipment including the rotation shaft becomes unstable, which can lead to damage to peripheral equipment and the rotation shaft of the rolling bearing, a gear and a coupling, a stator, a housing, a frame, or the like.

Concerning this, the rolling bearing 1 can diagnose a degree and a size of the damage to the rolling bearing 1 and the rotation equipment in which the rolling bearing 1 is provided with high accuracy by the attached diagnostic device 7. This makes it possible to prevent in advance a failure of peripheral equipment of the rolling bearing 1 and the whole rotation equipment in which the rolling bearing 1 is provided as well as the rolling bearing 1 itself.

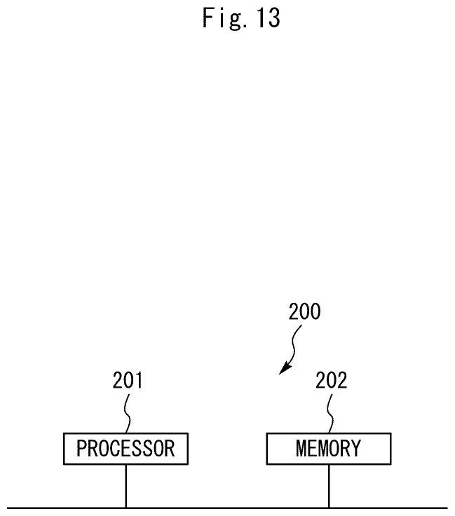

FIG. 13 is a diagram illustrating an example of a hardware configuration of the control unit of the diagnostic device according to any one of the first to the twenty-first embodiments.

The function of the control unit 9 can be implemented by a control circuit 200 illustrated in FIG. 13, that is, a processor 201 and a memory 202. Examples of the processor 201 can include a CPU (also referred to as a central processing unit, a processing unit, an arithmetic operation device, a microprocessor, a microcomputer, a processor, or a digital signal processor (DSP)), a system large scale integration (LSI), and the like. Examples of the memory 202 can include a random access memory (RAM), a read only memory (ROM), and the like.

The function of the control unit 9 can be implemented by the processor 201 reading a control program that is a program for causing the control unit 9 to execute processing from the memory 202 that stores the control program and executing the control program. Further, the control program can be regarded as a program for causing a computer to execute a control method of the diagnostic device 7 in the control unit 9. The control program to be executed by the control unit 9 has a module configuration in which various kinds of processing are modularized, the various kinds of processing including, for example, processing of calculating the evaluation speed, the specific coefficient, the evaluation index, the evaluation index statistic, or the like, based on the signal acquired from the behavior sensor 8 or the rotation sensor 15, and the like, processing of calculating an acceleration overall value, processing of judging whether or not damage has occurred, processing of diagnosing a damage condition, and the like. These modules are loaded on a main memory device and generated on the main memory device.

The memory 202 is used as a temporary memory when the processor 201 executes various kinds of processing. Further, in the seventh and the twentieth embodiments, the memory 202 is used as the storage unit 13 that stores the evaluation speed or the evaluation index such as the evaluation vibration as time-series data.

The control program to be executed by the processor 201 may be stored in a computer-readable storage medium as a file in an installable or executable format and provided as a computer program product. Further, the control program to be executed by the processor 201 may be provided to the control unit 9 of the diagnostic device 7 via a network such as the Internet.

Further, the control unit 9 may be implemented with dedicated hardware. Still further, some of the functions of the control unit 9 may be implemented by dedicated hardware, and the other may be implemented by software or firmware.

### Twenty-second Embodiment

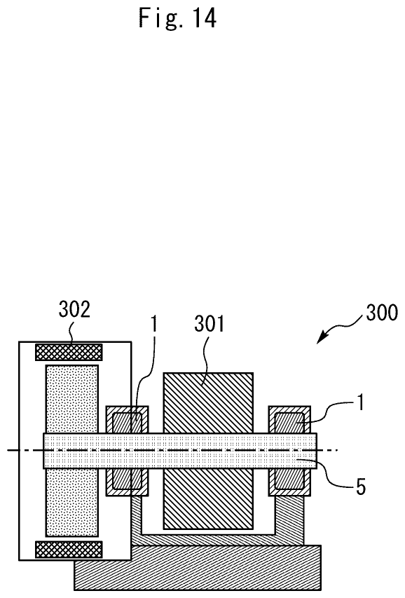

FIG. 14 is a configuration diagram of an elevator traction machine 300 according to a twenty-second embodiment.

In the present embodiment, the elevator traction machine 300 includes the rolling bearing 1, the rotation shaft 5, a sheave 301, and a motor 302.

A rope that moves a car of an elevator can be hung on the sheave 301. The motor 302 can move the car of the elevator while hoisting the rope, for example, by rotationally driving the rotation shaft 5 that is supported by two rolling bearings 1 to rotate the sheave 301.

Typically, a failure is likely to occur in the rolling bearing 1 of the traction machine 300 in which a large load and friction occur in parts that drive the elevator. According to the configuration of the present embodiment, damage to the rolling bearing 1 of the elevator traction machine 300 is diagnosed with high accuracy, so that it is possible to perform preventive maintenance of the rolling bearing 1. In addition, it is also possible to perform preventive maintenance of peripheral equipment of the traction machine 300 such as the motor 302 and the sheave 301 and the traction machine 300, in which damage secondarily occurs due to the damage to the rolling bearing 1.

While an example of a configuration where the inner ring 2 rotates in an integrated manner with the rotation shaft 5 has been described for the rolling bearing 1 according to any one of the first to the twenty-second embodiments, it is also possible to employ a configuration where the inner ring 2 is held and fixed in the housing 6. Further, while an example of a configuration where the outer ring 3 is held and fixed in the housing 6 has been described, it is also possible to employ a configuration where the outer ring 3 rotates in an integrated manner with the rotation shaft 5 provided outside the outer ring 3.

For the rolling bearing 1 according to any one of the first to the twenty-second embodiments, the number and arrangement of the rolling elements 4 are not limited to the number and arrangement illustrated in FIG. 1, FIG. 7, or the like.

While an example of a condition in which there is one damaged portion 100 has been described for the rolling bearing 1 or the diagnostic device 7 according to any one of the first to the twenty-second embodiments, there may be two or more damaged portions 100. Further, while an example of a case where the damaged portion 100 has occurred in the outer ring 3 has been described, the damaged portion 100 may occur in the inner ring 2 or the rolling element 4. Further, the damaged portion 100 may occur at a plurality of positions.

While an example of a configuration where there is one behavior sensor 8 has been described for the rolling bearing 1 or the diagnostic device 7 according to any one of the first to the twenty-second embodiments, there may be two or more behavior sensors 8. Further, a position and a shape of the behavior sensor 8 are not limited to the examples described above.

The diagnostic device 7 according to any one of the first to the twenty-second embodiments described above can be applied to any of the rolling bearing 1 to which a lubricant such as grease is supplied, the rolling bearing 1 to which a lubricant such as grease is not supplied, the rolling bearing 1 that is in rotation operation, and the rolling bearing 1 that stops rotation.

Note that in the present specification, expressions representing directions such as the “shaft direction”, the “radial direction”, the “circumferential direction”, the “rotation direction”, the “load direction”, and the “anti-load direction” not only include strictly indicated directions but also include directions in which substantially the same functions can be obtained. Further, in the present specification, expressions such as “comprise”, “provide”, “include” and “have” do not mean exclusive expressions that exclude existence of other components.

While various illustrative embodiments and examples are described in the present disclosure, various features, aspects and functions described in one or a plurality of embodiments are not limited to application in a specific embodiment, but can be applied to the embodiment alone or in various combinations. Thus, an infinite number of modifications which are not described are assumed within the scope of the technique of the present disclosure. It is assumed in one example that the modifications include modification, addition or omission of at least one component, and further, extraction of at least one component and combination of the component with components in other embodiments. Further, the configurations described above in the embodiments can be combined with another publicly known techniques. In other words, part of the configurations described above in the embodiments can be omitted or changed within a range not deviating from the gist.

### INDUSTRIAL APPLICABILITY

The diagnostic device according to the present disclosure can be applied to a rolling bearing. The rolling bearing according to the present disclosure can be applied to rotation equipment.

### REFERENCE SIGNS LIST

1 Rolling bearing, 2 Inner ring, 3 Outer ring, 4, 4a, 4b Rolling element, 5 Rotation shaft, 6 Housing, 7 Diagnostic device, 8 Behavior sensor, 9 Control unit, 10 First calculation unit, 11 Diagnosis unit, 12 Second calculation unit, 13 Storage unit, 14 Calculation unit, 15 Rotation sensor, 100 Damaged portion, 101 Recessed portion, 102 Damaged corner portion, 200 Control circuit, 201 Processor, 202 Memory, 300 Traction machine, 301 Sheave, 302 Motor

1. A diagnostic device that diagnoses a rolling bearing which comprises:
an inner ring;
an outer ring arranged concentrically with the inner ring; and
a plurality of rolling elements arranged between a raceway surface of the outer ring and a raceway surface of the inner ring, and each rolling in association with rotation of the inner ring or rotation of the outer ring,
the diagnostic device comprising:
a rotation sensor that is provided at rotation equipment including the rolling bearing;
a behavior sensor that is provided at the inner ring, the outer ring or a housing that holds the inner ring or the outer ring and measures behavior of the rolling bearing; and
processing circuitry
to calculate an evaluation speed based on information acquired by the behavior sensor, the evaluation speed being a maximum speed component in a direction of a load acting on the rolling bearing from a rotation shaft that rotates in an integrated manner with the inner ring or the outer ring within a period equal to or longer than a predetermined cycle, and
to diagnose damage to the rolling bearing by using an evaluation index based on the evaluation speed and a relative rotation speed of the inner ring and the outer ring;
wherein the relative rotation speed is obtained based on a measurement value of the rotation sensor, and
the predetermined cycle is a cycle of characteristic vibration determined by the relative rotation and specifications of the rolling bearing.

2. The diagnostic device according to claim 1, wherein the cycle of the characteristic vibration is determined by the specifications of the rolling bearing and the relative rotation speed, the specifications including a diameter of each rolling element and a diameter of a trajectory of a center of the rolling element when the rolling element rotationally moves in a circumferential direction around a central axis of the rotation shaft.

3. The diagnostic device according to claim 1, wherein the cycle of the characteristic vibration is determined by the specifications of the rolling bearing and the relative rotation speed, the specifications including a diameter of each rolling element, a diameter of a trajectory of a center of the rolling element, and a contact angle of the rolling element.

4. The diagnostic device according to claim 1, wherein the damage to the rolling bearing is diagnosed using, as the evaluation index, a relative evaluation speed obtained by dividing the evaluation speed by the relative rotation speed.

5. The diagnostic device according to claim 1, wherein a size of the damage to the rolling bearing is diagnosed based on the evaluation index, and a specific coefficient of the rolling bearing.

6. The diagnostic device according to claim 5, wherein the specific coefficient is determined based on a shape or a dimension of the rolling bearing.

7. The diagnostic device according to claim 6, wherein the specific coefficient is determined based on a diameter of a trajectory of a center of the rolling element when the rolling element rotationally moves in a circumferential direction around a central axis of the rotation shaft.

8. The diagnostic device according to claim 5, wherein the specific coefficient is determined based on a load acting on the rolling bearing from the rotation shaft.

9. The diagnostic device according to claim 8, wherein the specific coefficient is determined based on a maximum displacement of the inner ring, the outer ring or the housing in a direction in which a load from the rotation shaft acts within the period equal to or longer than the cycle of the characteristic vibration determined by the specifications of the rolling bearing, and the load acting on the rolling bearing from the rotation shaft.

10. The diagnostic device according to claim 5, wherein the specific coefficient is obtained based on actually measured data indicating a size of the damage to the rolling bearing, and data of the evaluation index in a condition of the rolling bearing.

11. The diagnostic device according to claim 1, wherein the processing circuitry diagnoses the damage to the rolling bearing by using an evaluation index statistic obtained by separating a period longer than a revolution cycle of each rolling element when the rolling element rotationally moves in a circumferential direction around a central axis of the rotation shaft into a plurality of periods each equal to or longer than the cycle of the characteristic vibration and performing statistical processing on a data group of a plurality of the evaluation indexes respectively calculated within the separated plurality of periods.

12. The diagnostic device according to claim 1, wherein the processing circuitry diagnoses a degree of the damage or a position of the damage or both of the degree and the position of the damage to the rolling bearing based on a cyclic change of the evaluation index that is continuously calculated.

13. The diagnostic device according to claim 12, wherein the processing circuitry diagnoses the degree of the damage or the position of the damage or both of the degree and the position of the damage to the rolling bearing using frequency analysis data of time-series data of the evaluation index that is continuously calculated.

14. The diagnostic device according to claim 1, wherein the rotation sensor measures the relative rotation speed.

15. The diagnostic device according to claim 1, wherein
the processing circuitry accumulates and stores the evaluation index or a change amount of the evaluation index, and
the processing circuitry diagnoses the damage to the rolling bearing based on a time-differential value of the evaluation index that can be calculated from information stored in the processing circuitry.

16. The diagnostic device according to claim 15, wherein the processing circuitry calculates a period until occurrence of damage leading to loss of a function of the rolling bearing or loss of a function of the whole rotation equipment including the rolling bearing based on the evaluation index stored in the processing circuitry or a temporal change rate of the evaluation index that can be calculated from the information stored in the processing circuitry and calculates an appropriate maintenance and check time of the rolling bearing to prevent in advance the damage leading to loss of the function.

17. A rolling bearing comprising:
an inner ring;
an outer ring arranged concentrically with the inner ring;
a plurality of rolling elements arranged between a raceway surface of the outer ring and a raceway surface of the inner ring and each rolling in association with rotation of the inner ring or rotation of the outer ring; and
the diagnostic device according to claim 1.

18. An elevator traction machine comprising:
a rolling bearing which comprises:
an inner ring;
an outer ring arranged concentrically with the inner ring;
a plurality of rolling elements arranged between a raceway surface of the outer ring and a raceway surface of the inner ring and each rolling in association with rotation of the inner ring or rotation of the outer ring; and
the diagnostic device according to claim 1;
a sheave;
a rotation shaft that rotates in an integrated manner with part of the sheave and the rolling bearing; and
a motor that rotates the rotation shaft.
